(19) United States
(12) Patent Application Publication
(10) Pub. No.: US 2015/0099458 A1
(43) Pub. Date: Apr. 9, 2015

(54) Network-Capable Medical Device for Remote Monitoring Systems

(71) Applicant: Covidien LP, Mansfield, MA (US)

(72) Inventors: Joel D. Weisner, St. Peters, MO (US); Robert B. Gaines, Lake St. Louis, MO (US)

(21) Appl. No.: 14/501,632

(22) Filed: Sep. 30, 2014

Related U.S. Application Data
(63) Continuation-in-part of application No. 14/308,881, filed on Jun. 19, 2014.
Application No. 14/308,881 is a continuation of application No. 13/241,620, filed on Sep. 23, 2011, now Pat. No. 8,798,527.
Application No. 13/241,620 is a continuation-in-part of application No. 13/006,769, filed on Jan. 14, 2011, now Pat. No. 8,818,260.
Application No. 13/006,769 is a continuation-in-part of application No. 14/462,025, filed on Aug. 18, 2014.
Application No. 14/462,025 is a continuation of application No. 14/308,881, filed on Jun. 19, 2014.
Application No. 14/308,881 is a continuation of application No. 13/352,575, filed on Jan. 18, 2012, now Pat. No. 8,811,888.
Application No. 13/352,575 is a continuation-in-part of application No. 13/241,620, filed on Sep. 23, 2011, now Pat. No. 8,798,527.
Application No. 13/241,620 is a continuation-in-part of application No. 13/006,769, filed on Jan. 14, 2011, now Pat. No. 8,818,260.
Application No. 14/462,025 is a continuation of application No. 13/334,459, filed on Dec. 22, 2011, now Pat. No. 8,855,550.
Application No. 13/334,459 is a continuation-in-part of application No. 13/006,769, filed on Jan. 14, 2011, now Pat. No. 8,818,260.
Application No. 14/462,025 is a continuation of application No. 13/334,447, filed on Dec. 22, 2011, now Pat. No. 8,903,308.
Application No. 13/334,447 is a continuation-in-part of application No. 13/006,769, filed on Jan. 14, 2011, now Pat. No. 8,818,260.
Application No. 14/462,025 is a continuation of application No. 13/006,769, filed on Jan. 14, 2011, now Pat. No. 8,818,260.
Application No. 13/006,769 is a continuation of application No. 13/006,784, filed on Jan. 14, 2011, now Pat. No. 8,897,198.
Application No. 13/006,784 is a continuation of application No. 13/334,463, filed on Dec. 22, 2011.
Application No. 13/334,463 is a continuation of application No. 13/353,565, filed on Jan. 19, 2012.
Application No. 13/353,565 is a continuation-in-part of application No. 13/334,463, filed on Dec. 22, 2011.
Application No. 13/334,463 is a continuation-in-part of application No. 13/006,769, filed on Jan. 14, 2011, now Pat. No. 8,818,260.
Application No. 14/462,025 is a continuation of application No. 13/352,608, filed on Jan. 18, 2012.
Application No. 13/352,608 is a continuation-in-part of application No. 13/037,886, filed on Mar. 1, 2011, now Pat. No. 8,694,600.
Application No. 14/462,025 is a continuation of application No. 14/154,285, filed on Jan. 14, 2014, now Pat. No. 8,943,168.
Application No. 14/154,285 is a continuation of application No. 13/037,886, filed on Mar. 1, 2011, now Pat. No. 8,694,600.
Application No. 13/037,886 is a continuation-in-part of application No. 13/334,459, filed on Dec. 22, 2011, now Pat. No. 8,855,550.
Application No. 13/334,459 is a continuation-in-part of application No. 13/334,447, filed on Dec. 22, 2011, now Pat. No. 8,903,308.
Application No. 13/334,447 is a continuation-in-part of application No. 13/006,784, filed on Jan. 14, 2011, now Pat. No. 8,897,198.
Application No. 13/006,784 is a continuation-in-part of application No. 13/352,565, filed on Jan. 18, 2012.
Application No. 13/352,565 is a continuation-in-part of application No. 13/352,608, filed on Jan. 18, 2012.
Application No. 14/462,025 is a continuation of application No. 13/241,620, filed on Sep. 23, 2011, now Pat. No. 8,798,527.

(51) Int. Cl. H04B 7/155; G06F 19/00

(52) U.S. Cl. CPC H04B 7/155; G06F 19/3418
USPC 455/15

(57) ABSTRACT

Systems and methods for communication include a medical device having a first receiver capable of wirelessly receiving medical device data over a wireless relay network from at least one network device, a first transmitter capable of wirelessly transmitting data over an internet-accessible wireless communications network, a second transmitter capable of wirelessly transmitting medical device data to a second medical device or a wireless relay module over the wireless relay network; and a controller coupled to the first and second transmitters, said controller capable of controlling said medical device to select one of said first or second transmitter for transmitting medical device data received by said first receiver.

### RELATED APPLICATIONS

This application is a continuation-in-part of co-pending U.S. patent application Ser. No. 14/308,881 filed Jun. 19, 2014 which is a continuation of U.S. patent application Ser. No. 13/241,620 filed Sep. 23, 2011, now U.S. Pat. No. 8,798,527, which is a continuation-in-part of U.S. patent application Ser. No. 13/006,769 filed Jan. 14, 2011, now U.S. Pat. No. 8,818,260.

This application is also a continuation-in-part application of co-pending U.S. patent application Ser. No. 14/462,025 filed Aug. 18, 2014, which is a continuation of U.S. patent application Ser. No. 14,308,881 filed Jun. 19, 2014, which is a continuation of U.S. patent application Ser. No. 13/241,620 filed Sep. 23, 2011, now U.S. Pat. No. 8,798,527, which is a continuation-in-part of U.S. patent application Ser. No. 13/006,769 filed Jan. 14, 2011, now U.S. Pat. No. 8,818,260. U.S. patent application Ser. No. 14/462,025 is also a continuation of U.S. patent application Ser. No. 13/352,575 filed Jan. 18, 2012, now U.S. Pat. No. 8,811,888, which is a continuation in part of U.S. patent application Ser. No. 13/241,620 filed Sep. 23, 2011, now U.S. Pat. No. 8,798,527, and U.S. patent application Ser. No. 13/006,769 filed Jan. 14, 2011, now U.S. Pat. No. 8,818,260. U.S. patent application Ser. No. 14/462,025 is also a continuation of U.S. patent application Ser. Nos. 13/334,459; 13/334,447; 13/006,784; 13/006,769; 13/334,463; 13/353,565; 13/352,608; and 14/154,285.

This application is also a continuation-in-part application of co-pending U.S. patent application Ser. No. 13/334,447 filed Dec. 22, 2011 which is a continuation-in-part application of U.S. patent application Ser. No. 13/006,769 filed Jan. 14, 2011.

This application is also a continuation-in-part application of co-pending U.S. patent application Ser. No. 13/334,459 filed Dec. 22, 2011 which is a continuation-in-part of U.S. patent application Ser. No. 13/006,769 filed Jan. 14, 2011.

This application is also a continuation-in-part application of co-pending U.S. patent application Ser. No. 13/353,565 filed Jan. 19, 2012 which is a continuation-in-part of U.S. patent application Ser. No. 13/334,463 filed Dec. 22, 2010 and a CIP application of U.S. patent application Ser. No. 13/006,769 filed Jan. 14, 2011.

This application is also a continuation-in-part application of co-pending U.S. patent application Ser. No. 13/352,608 filed Jan. 18, 2012, which is a continuation-in-part of U.S. patent application Ser. No. 13/037,886 filed Mar. 1, 2011 no U.S. Pat. No. 8,694,600.

This application is also a continuation-in-part application of co-pending U.S. patent application Ser. No. 13/006,784 filed Jan. 14, 2011.

All patents, patent applications, and publications listed in this section and listed in this document are incorporated here by reference in their entireties.

### FIELD

The present application is directed to a relay module for communicating between a series of medical devices and remote monitoring devices, and more particularly, to a wireless relay module for receiving communications from and transmitting communications to medical devices via a wireless relay network, and for transferring the communications received from the remote monitoring devices via an Internet-accessible wireless communications network.

### BACKGROUND

In critical care and home care health service centers including hospitals, clinics, assisted living centers and the like, care giver-patient interaction time is at a premium. Moreover, response times by care givers to significant health conditions and events can be critical. Systems of centralized monitoring have been developed to better manage care giver time and patient interaction. In such systems, medical data from each patient is transmitted to a centralized location. At this centralized location, a single or small number of technicians monitor all of this patient information to determine patient status. Information indicating a patient alarm condition will cause the technicians and/or system to communicate with local care givers to provide immediate patient attention, for example via wireless pagers and/or cell phones, and/or by making a facility-wide audio page.

Implementing such centralized monitoring systems using wireless networks may present a number of difficulties. In order to effectively monitor patient status using information provided by a variety of medical devices that may be dynamically assigned to patients in a variety of rooms and on a variety of floors in a facility, it would be desirable to establish communications between the medical devices and the centralized location by means of a local area network such as, for example, a “WiFi” network based on IEEE 802.11 standards. However, as such networks are typically already in place in facilities to support a variety of other functions (for example, physician access to electronic medical records (EMRs), facility administrative systems and other functions), it is often undesirable to secure sufficient local area network access for the purpose of providing centralized monitoring. Moreover, when a patient is located remotely from a critical care health service center (for example, at home), access to traditional local area network facilities such as a WiFi network may be unavailable or not sufficiently reliable to support critical care monitoring applications.

### SUMMARY

In one aspect, the concepts, systems, circuits and techniques described herein are directed toward a relay network formed from a plurality of medical devices and one or more relay modules. At least one of the one or more relay modules is capable of transmitting information provided thereto to a remote monitoring device over an internet-accessible wireless communication network, and preferably, a wireless wide-area network (WWAN) such as a mobile telephone data network including (for example, based on a Global System for Mobile Communications (GSM) or Code Division Multiple Access (CDMA) cellular network or associated wireless data channels). At least two of the plurality of medical devices are capable of transmitting information between each other and between at least one relay module in the network. The at least one relay module is capable of transmitting information provided thereto to a remote monitoring device over an internet-accessible wireless communication network.

In one aspect, the concepts, systems, circuits and techniques described herein are directed toward are method of transmitting medical information through a wireless relay network comprising a plurality of medical devices capable of wireless data communication and at least one wireless relay module. The method includes receiving medical information in a first medical device, transmitting the medical information from the first medical device to a second medical device through the wireless relay network, in response to the second medical device receiving information from the first medical device, transmitting the medical information from the second medical device over the wireless relay network to a first wireless relay module and in response to the first wireless relay module receiving medical information over the wireless relay network from the second medical device, selecting, by the first wireless relay module, an internet accessible communication path and transmitting the medical information from the first wireless relay module over the selected internet accessible communication path.

In one embodiment, transmitting the medical information from the first wireless relay module over the selected internet accessible communication path includes the first wireless relay module determining an access status of an internet accessible wireless communications network in communication with a transmitter of the wireless relay module and determining a device status for at least one of the first and second medical devices and a connection status between at least one of the first and the second medical devices and the wireless relay module.

In one embodiment, transmitting the medical information from the first wireless relay module over the selected internet accessible communication path further includes in response to the device status for the first or second medical device, the determined access status of the wireless relay network, and the connection status of the transmitter and the wireless relay module satisfying a particular criteria, transmitting the medical information from the second medical device over the selected internet accessible communication path.

In one embodiment, the first wireless relay module is a first one of a plurality of wireless relay modules in the wireless relay network and at least one of the plurality of wireless relay modules includes a first transmitter for transmitting over the internet accessible communication path and a second transmitter for transmitting over the wireless relay network.

In one embodiment, transmitting the medical information from the first wireless relay module over the selected Internet accessible communication path includes the first wireless relay module communicating with at least one of the plurality of wireless relay modules in the wireless relay network, the first wireless relay module determining an access status of the Internet accessible wireless communications network in communication with the first transmitter of the first wireless relay module, and a device status for each of the at least one medical devices, and a connection status of the second transmitter of first wireless relay module and the wireless relay network.

In one embodiment, in response to the determined access status of the wireless relay network, device status for at least one of the medical devices, and connection status of the first transmitter of the first wireless relay module satisfying a particular criteria, transmitting the medical information from the second medical device over the selected Internet accessible communication path via the first transmitter of the first wireless relay module.

In one embodiment, in response to the determined access status of the wireless relay network, device status for at least one of medical devices, and connection status of the first transmitter of the first wireless relay module failing to satisfy the particular criteria, transmitting the medical information over the wireless relay network via the second transmitter of the first wireless relay module to a second wireless relay module.

In one embodiment, in response to transmitting the medical information over the wireless relay network via the second transmitter of the first wireless relay module, the method further includes: receiving the medical information in the second wireless relay module, the second wireless relay module determining an access status of the Internet accessible wireless communications network in communication with the first transmitter of the second wireless relay module, and a connection status of the second transmitter of second wireless relay module and the wireless relay network.

In one embodiment, in response to the determined access status of the wireless relay network and connection status of the first transmitter of the second wireless relay module satisfying a particular criteria, the method further includes transmitting the medical information received from the second medical device over the selected Internet accessible communication path via the first transmitter of the second wireless relay module.

In one embodiment, the first wireless relay module is a first one of a plurality of wireless relay modules in the wireless relay network and at least one of the plurality of wireless relay modules includes a first transmitter for transmitting over an Internet accessible communication path and a second transmitter for transmitting over the wireless relay network and the wireless relay network further includes one or more interface circuits in communication with one or more of the plurality of medical devices and one or more of the wireless relay modules, and the method further includes the first wireless relay module communicating with one of a plurality of medical devices and/or wireless relay modules in the wireless relay network, the first wireless relay module determining an access status of an Internet accessible communication path in communication with a first transmitter of the first relay module, and a device status for at least one of the plurality of medical devices and a connection status of the first transmitter of the first wireless relay module.

In one embodiment, the first wireless relay module further includes transmitting the medical information from at least one of the plurality of medical devices over the Internet accessible communication path by the first transmitter if the determined access status of the wireless relay network, device status for at least one medical device, and connection status of the first transmitter of the first wireless relay module satisfy a particular criteria and transmitting the medical information from at least one of the plurality of medical devices by a second transmitter in communication with the wireless relay network to a second relay module over the wireless relay network if the determined access status of the wireless relay network, device status of at one medical device, and connection status of the first transmitter in the wireless relay module fail to satisfy the particular criteria.

In general, the relay module provides networked communications between a series of medical devices and one or more monitoring devices located remotely from the medical devices. In some embodiments, at least a portion of the communication path between the medical devices and the one or more monitoring devices takes place includes an internet.

In accordance with some embodiments of the disclosed technology, one or more medical devices (including but not limited to including for example, respirators, external feeding devices, pulse oximeters, blood pressure monitors, pulse monitors, weight scales and glucose meters) are provided at a patient facility.

In accordance with some embodiments an interface circuit is coupled to each medical device, and is configured for communicating with at least one of a plurality of the wireless relay modules via a wireless relay network and/or with other medical devices. In other embodiments the medical devices include integral circuitry which provide the requisite communication capability between the medical device and the relay module.

The wireless relay modules and medical devices are advantageously further configured to communicate with a remote monitoring device over an internet-accessible wireless communication network, and preferably, a wireless wide-area network (WWAN) such as a mobile telephone data network including (for example, based on a Global System for Mobile Communications (GSM) or Code Division Multiple Access (CDMA) cellular network or associated wireless data channels). Also, for compliance for example with HIPAA regulations, communications over each of the wireless networks are preferably conducted securely.

Systems and methods for communication include a medical device having a first receiver capable of wirelessly receiving medical device data over a wireless relay network from at least one network device, a first transmitter capable of wirelessly transmitting data over an internet-accessible wireless communications network, a second transmitter capable of wirelessly transmitting medical device data to a second medical device or a wireless relay module over the wireless relay network; and a controller coupled to the first and second transmitters, said controller capable of controlling said medical device to select one of said first or second transmitter for transmitting medical device data received by said first receiver.

In another aspect of the concepts, systems, circuits and techniques described herein described is a wireless relay module for providing networked communications between a series of medical devices and remote monitoring devices. In accordance with embodiments of the disclosed technology, one or more medical devices (including but not limited to including for example, respirators, external feeding devices, pulse oximeters, blood pressure monitors, pulse monitors, weight scales and glucose meters) are provided at a patient facility. An interface circuit is coupled to each medical device, and is configured for communicating with at least one of a plurality of the wireless relay modules via a wireless relay network and/or with other medical devices. The wireless relay modules and medical devices are advantageously further configured to communicate with a remote monitoring device over an internet-accessible wireless communication network, and preferably, a wireless wide-area network (WWAN) such as a mobile telephone data network including (for example, based on a Global System for Mobile Communications (GSM) or Code Division Multiple Access (CDMA) cellular network or associated wireless data channels). Also, for compliance for example with HIPAA regulations, communications over each of the wireless networks are preferably conducted securely.

Systems and methods for communication include a medical device having a first receiver capable of wirelessly receiving medical device data over a wireless relay network from at least one network device, a first transmitter capable of wirelessly transmitting data over an internet-accessible wireless communications network, a second transmitter capable of wirelessly transmitting medical device data to a second medical device or a wireless relay module over the wireless relay network; and a controller coupled to the first and second transmitters, said controller capable of controlling said medical device to select one of said first or second transmitter for transmitting medical device data received by said first receiver.

### BRIEF DESCRIPTION OF THE DRAWINGS

The subject of this disclosure will become more readily apparent from the Detailed Description, which proceeds with reference to the drawings, in which:

FIG. 1A presents a block diagram of a medical device network architecture that incorporates a wireless relay module.

FIG. 1B is a perspective diagram of a personal enclosure for a medical device and/or a relay module.

FIG. 2A is a network diagram of a network including medical devices and/or relay modules.

FIG. 2B is a network diagram of a network including medical devices and/or relay modules.

FIGS. 3A-3D are block diagrams of embodiments of relay modules.

FIGS. 3E-3G are top, front, and side views of a relay module.

FIG. 3H is a diagram of a control panel associated with a relay module.

FIG. 3I is a diagram of a control panel associated with a relay module.

FIG. 4A is a flow diagram of processes for transmitting medical device data.

FIG. 4B is a flow diagram of processes for transmitting medical device data.

FIG. 4C is flow diagram of a process including determining module status.

FIG. 4D is a flow diagram of a process including determining WWAN status.

FIG. 4E is a flow diagram of a process including determining WLAN/WPAN status.

FIG. 4F is a flow diagram of a process including initiating a call to an emergency responder.

FIG. 4G is a flow diagram of a process including producing location data.

FIG. 4H is a table diagram of priority codes.

FIG. 5 is a flow diagram of a process including determining whether an interface device is accessible.

FIG. 6A and FIG. 6B are flow diagrams including producing an alert.

FIG. 6C is a flow diagram including transmitting a power alarm.

FIG. 6D is a flow diagram including transmitting a low battery alarm.

FIG. 7 is a flow diagram including sending a heartbeat request to a medical device.

FIG. 8 is a network diagram of a network including medical devices and/or relay modules.

FIG. 9 is a network diagram of a network including medical devices and/or relay modules.

FIG. 10 is a network diagram of a network including medical devices and/or relay modules.

### DETAILED DESCRIPTION

Reference will now be made in detail to embodiments of systems, apparatuses, and methods for communicating medical data, including the best modes contemplated by the inventors. Examples of these embodiments are illustrated in the accompanying drawings. While the systems, apparatuses, and methods are described in conjunction with these embodiments, it will be understood that it is not intended to limit the claims to the described embodiments. Rather, the claims are also intended to cover alternatives, modifications, and equivalents as may be included within the spirit and scope of the claims.

In the following description, specific details are set forth in order to provide a thorough understanding of the technology disclosed. The technology may be practiced without some or all of these specific details. In other instances, well-known aspects have not been described in detail in order not to unnecessarily obscure the description of the technology.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art.

Further described herein is a network architecture for centralized monitoring of medical devices using wireless relay networks and/or internet-accessible wireless communications networks having emergency call functionality to provide a secondary level of protection when significant health conditions occur. The architecture in addition enables the approximate location of the monitored medical devices to be determined.

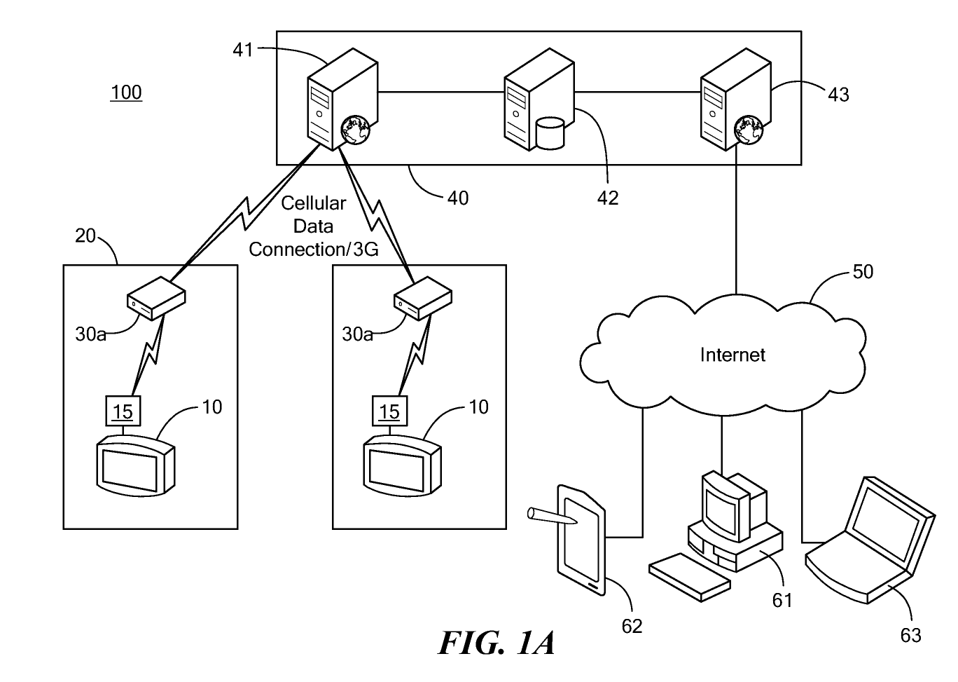

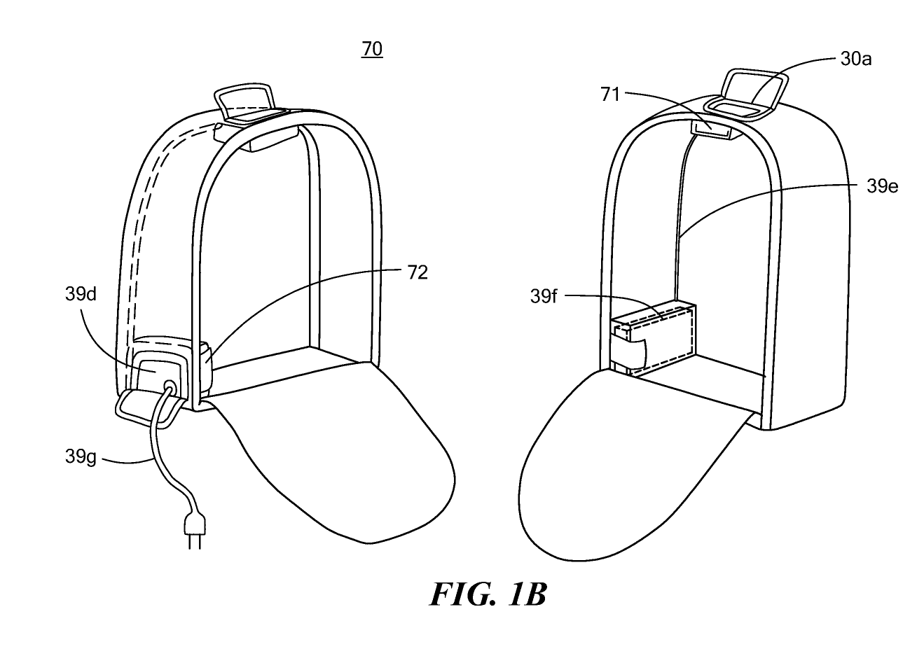

A schematic diagram of an architecture 100 for a system for monitoring medical devices is illustrated in FIG. 1A. One or more medical devices 10 are provided at a patient facility 20 for monitoring the medical condition and/or administering medical treatment to one or more patients. Patient facility 20 may comprise a critical care health service center (for example, including hospitals, clinics, assisted living centers and the like) servicing a number of patients, a home facility for servicing one or more patients, or a personal enclosure (for example, a backpack) that may attached to and/or be worn by an ambulatory patient. Associated with each medical device 10 is an interface circuit 15 that includes a transceiver having one or more of a transmitter and/or a receiver for respectively transmitting and receiving signals in a facility-oriented wireless network such as, for example, a Low-Rate Wireless Personal Area Networks or “LR-WPAN,” ZIGBEE network or other low-power personal area networks such as a low power BLUETOOTH network, e.g. Bluetooth 4.0, existing or presently under development or consideration, for emulating a mesh network (such as ZIGBEE network) or otherwise. See, e.g., ZIGBEE Wireless Sensor Applications for Health, Wellness and Fitness, the ZIGBEE Alliance, March 2009, which is incorporated by reference herein in its entirety, for all purposes. See, also, Nick Hunn, Essentials of Short-Range Wireless, Cambridge University Press, 2010, which is also incorporated by reference herein in its entirety; See also Honda Labiod et al., Wi-Fi, Bluetooth, Zigbee and WiMax, Springer 2010, which is incorporated by reference herein in its entirety.

As illustrated in FIG. 1A, a suitable access point 40 may include an inbound web server 41 that incorporates or otherwise has access to a transceiver for communicating with the relay modules 30a over the WWAN. Medical device data received by the inbound web server 41 over the WWAN is forwarded to a secure data storage server 42, which is configured for example to log the received data in association with identification information of the associated medical devices. As was previously described infra, “medical device data” and “data” as generally used herein means data from or about the medical device including, for example, medical device identification, medical device software, medical device settings or status information (including alarm information and/or alarm priority), patient identification information, patient personal identification number(s) “PIN(s)”, patient prescriptions, and/or patient medical and/or physiological data as is collected, produced and/or generated by the medical device.

An outbound web server 43 (which may be associated with access point 40) is configured, for example, to receive and qualify data retrieval requests submitted by one or more of remote monitoring devices 61, 62 and 63 over a broad-band network 50 (for example, over the Internet), to request associated medical device data to be retrieved from the secure data storage server 42, and to format and transmit the retrieved data to the one or more remote monitoring devices 61, 62 and 63 for display on associated device displays. It should be understood that any architecture for the access point 40 that enables the receipt, storage and retrieval of medical device data on a device display of the one or more remote monitoring devices 61, 62 and 63 is intended to be included within the scope of the technology disclosed here. Variations of the architecture may involve utilizing a web server integrated with a data storage server. For example, storage server 42 may be integrated into the outbound web server 43. Further alternative configurations may for example involve a plurality of mirror storage servers 42 each storing medical device data, and accessible as a plurality of outbound web servers 43.

For compliance with HIPAA regulations, communications over each of the facility-oriented wireless network and WWAN are preferably conducted securely using, for example, using a Secure Sockets Layer (SSL) protocol or a Transport Layer Security (TLS) protocol.

FIG. 1B illustrates a backpack 70 as may be suitable for use as a personal enclosure. The backpack 70 includes a pouch 71 for housing a relay module 30a, a pouch 72 for housing a power and charging circuit 39d for providing power to the relay module 30a, and a power cord 39e for supplying power from the power and charging circuit 39d to the relay module 30a. As depicted, the power and charging circuit 39d includes a battery compartment 39f, and a charging circuit (not shown) and a power cord 39g for providing external commercial AC power to the power and charging circuit 39d in order to charge batteries in the battery compartment 39f. One of ordinary skill in the art will readily appreciate that the backpack 70 provides but one of a number of suitable backpack arrangements.

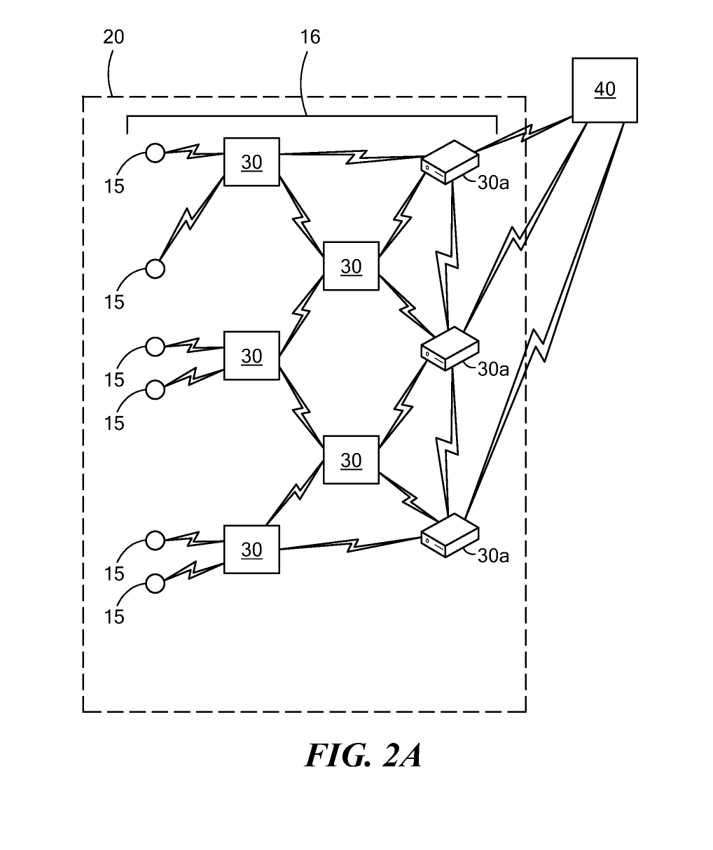

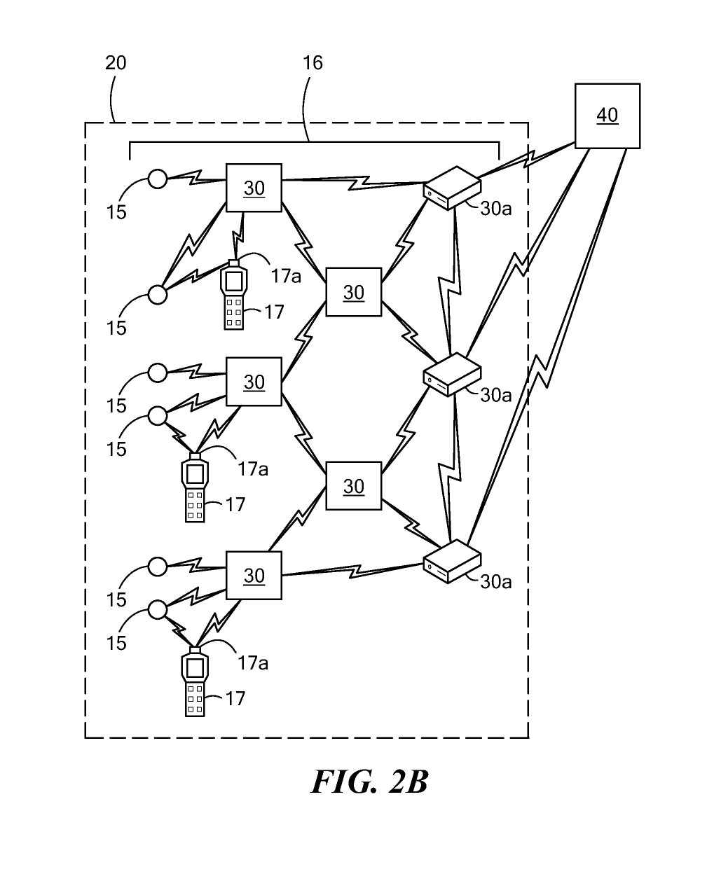

FIG. 2A presents a block diagram that further illustrates components of the inventive architecture that are located within or otherwise associated with the patient facility 20. In FIG. 2A, a number of interface circuits 15 and relay modules 30, 30a are arranged in a network 16, which may be a wireless relay network or mesh network 16 within the patient facility 20. It should be understood that network 16 is shown for illustration purposes only; other interface circuits 15 and relay modules 30, 30a may communicate over other wireless relay networks that are the same as or similar to network 16 in the patient facility 20.

In FIG. 2A, the interface circuits 15 and relay modules 30, 30a are configured to communicate with one another via associated wireless links. In an embodiment represented in FIG. 2A, the network 16 is a self-configurable mesh network and can also be a self-healing mesh network, for example a ZIGBEE compliant-mesh network based on the IEEE 802.15.4 standard. However, the wireless relay network 16 or additional wireless relay networks in the patient facility may be organized according to a variety of other wireless local area network (WLAN) or WPAN formats including, for example, WiFi WLANs based on the IEEE 802.11 standard and BLUETOOTH WPANs based on the IEEE 802.15.1 standard.

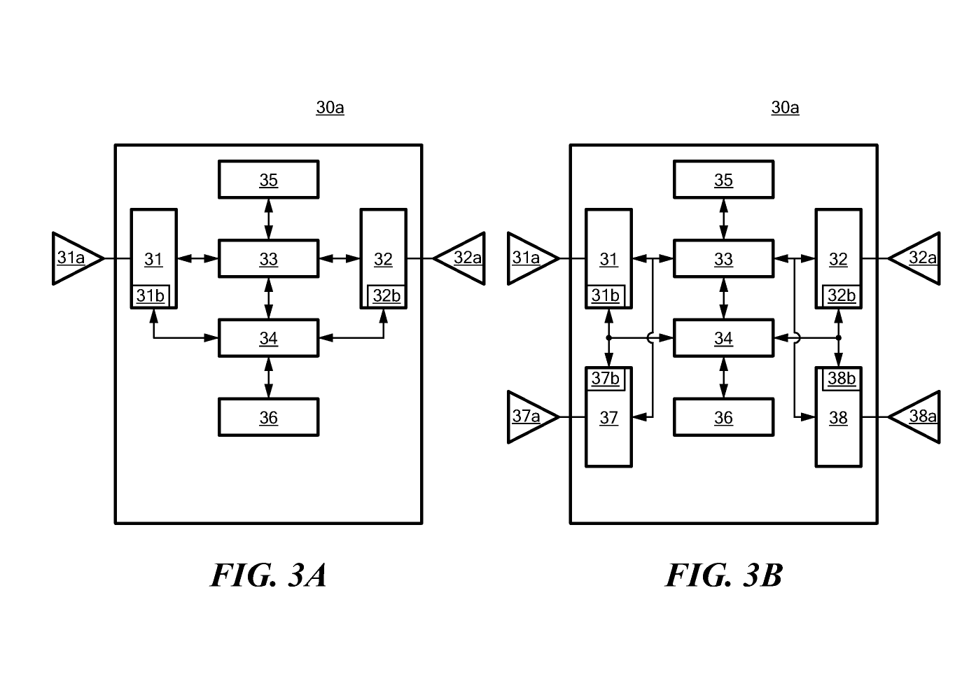

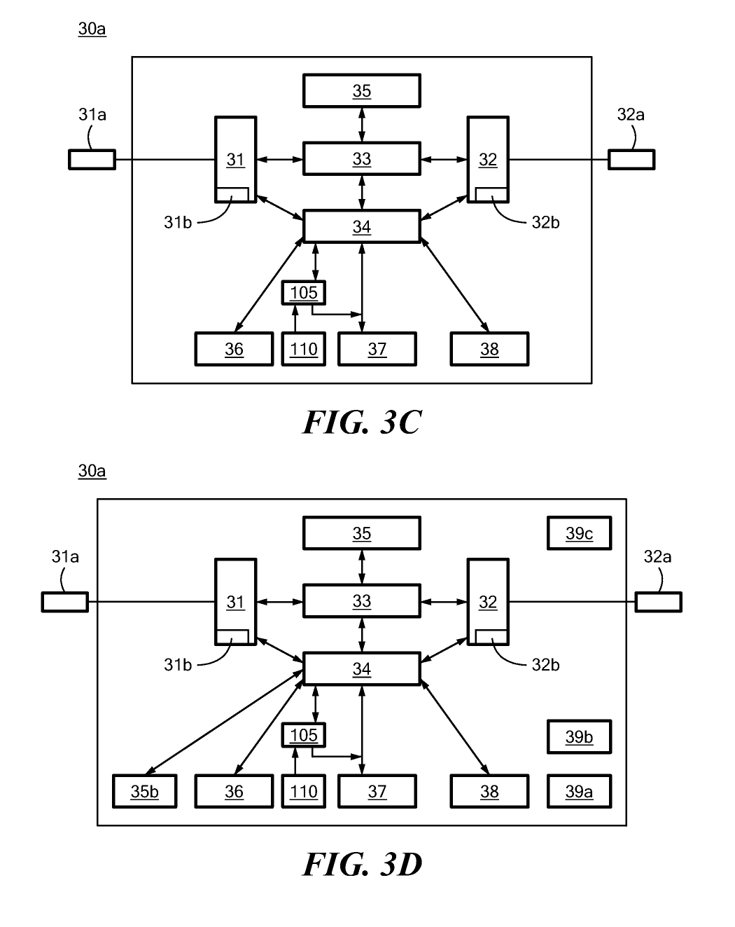

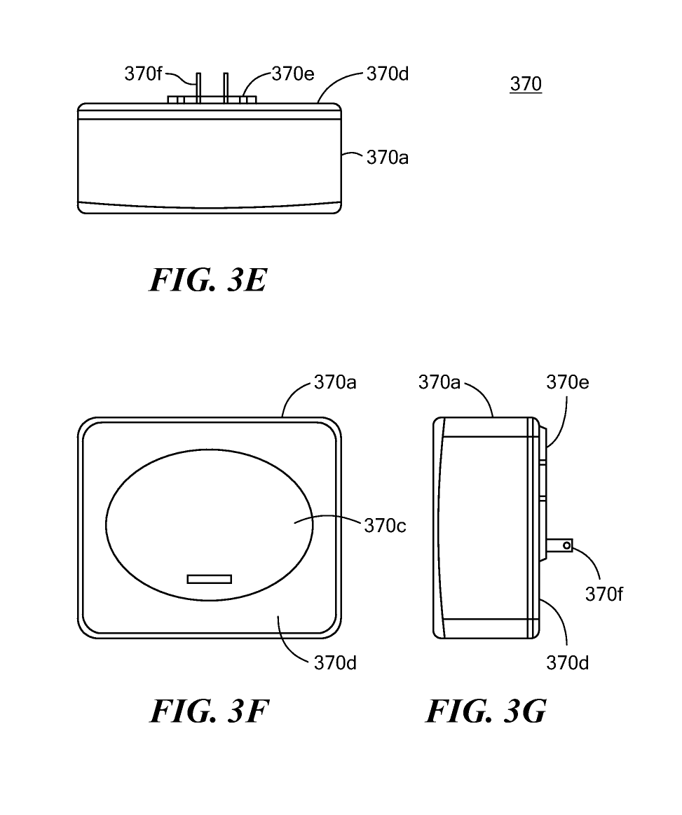

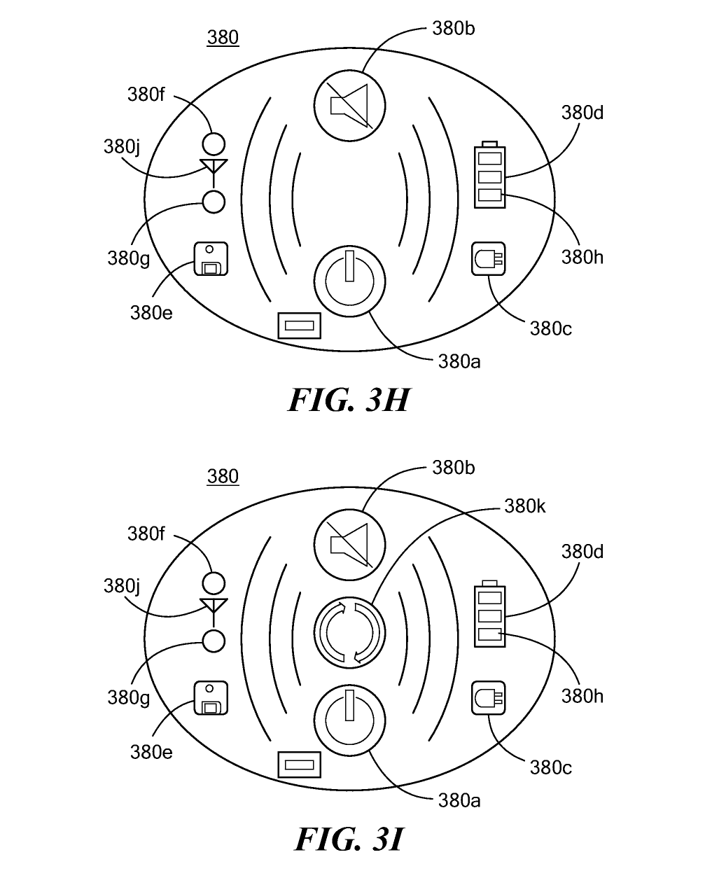

Each of the relay modules 30, 30a includes at least one transceiver configured to communicate with other relay modules 30, 30a in the wireless relay network 16. Relay modules 30a also may include at least a second transceiver for communicating over the WWAN with the access point 40. As further described in greater detail with regard to FIG. 3A-3D, each relay module 30 and/or 30a of FIG. 2A includes a first transceiver 31 for receiving signals from and transmitting signals to the interface circuits 15 in one or more of the facility-oriented wireless networks. Relay module 30a, as depicted in FIG. 3A for example, corresponds to relay modules 30 or 30a in FIG. 2A and may include a second transceiver 32 for wirelessly transmitting signals to and receiving signals from an access point 40 via a wireless wide-area network or “WWAN”. Suitable WWANs include, for example, networks based on a Global System for Mobile Communications (GSM) or Code Division Multiple Access (CDMA) cellular network or associated with the 2G, 3G, 3G Long Term Evolution, 4G, WiMAX cellular wireless standards of the International Telecommunication Union Radio communication Sector (ITU-R). Additional suitable WWANs include metropolitan area networks (MANS), campus area networks (CANs), local area networks (LANs), home area networks (HANs), personal area networks (PANs) and body area networks (BANs). It should be readily understood that the relay module 30a may include additional transceivers for communicating with additional WWANs or additional facility-oriented wireless networks.

As shown in FIG. 2B, the architecture may further include one or more wireless patient identification devices 17 in communication with one or more of the relay modules 30a and/or medical devices 10 in proximity to the patient identification device 17 via the interface circuits 15 and 17a operating over the facility-oriented wireless network. Alternatively, a wireless patient identification receiver may be integrated with each medical device 10, and access the facility-oriented wireless network via an associated interface circuit 15. The wireless patient identification devices 17 each receive patient identification data from a patient in proximity to the device 17 that uniquely identifies the patient using one of a variety of commercially-available sensors. For example, each patient identification device 17 may include a camera or other optical scanner and associated circuitry for sensing a barcode (for example, a UPC code or a QR matrix barcode) attached to or otherwise uniquely associated with a patient, such as a patient's wristband. Alternatively, each patient identification receiver 17 may include a radio-frequency identification (RFID) sensor and associated circuitry for sensing an RFID tag embedded in the patient wristband, or another commercially-available radio-frequency sensor capable of sensing an identification signal generated by a radio-frequency transmitter embedded in the patient wristband or otherwise provided as attached to or in proximity to the patient. Finally, each device 17 may in addition or instead include a commercially-available biometric sensor and associated circuitry for patient identification (for example, including one or more of a fingerprint reader, a retinal scanner or a vein-pattern scanner).

In the illustrated wireless relay network 16, each of the interface circuits 15 includes a communications interface such as, for example, a wired or wireless communications interface, to an associated medical device 10. In addition, each of the relay modules 30, 30a includes at least one transceiver configured to communicate with other relay modules 30, 30a in the wireless relay network 16. Relay modules 30a further include at least a second transceiver for communicating over the WWAN with the access point 40.

Each of the transceivers 31, 32 will typically include a mesh network transmitter (e.g. a ZIGBEE transmitter) for transmitting medical device data over one of the mesh network 16 or the WWAN, and a received for receiving medical device data transmitted over one of the mesh network 16 or the WWAN.

In accordance with IEEE 802.14.15, if the network 16 is a ZIGBEE mesh network then there is little risk that communications from more than one medical device will contend for simultaneous access to the network 16. The network 16 operates with a protocol in which a transmitting device checks for energy on a wireless bus component of the network 16. If the bus is in use, the transmitting device waits a preselected amount of time before checking again, and only proceeds to transfer data when the energy level suggests that no other transmission is actively underway on the wireless bus. Nevertheless, for circumstances in which data packets transmitted by the medical devices 10 arrive at a relay module 30, 30a at nearly at the same time, there may be a need to manage an order of delivery by the relay module 30.

The representative ZIGBEE mesh network 16 provides the advantages of being self-configurable when one or more interface circuits 15 and/or relay modules 30, 30a are added to the network, and self-healing when one or more interface circuits 15 and/or relay modules 30, 30a are removed from or otherwise disabled in the network. Sub-groupings of the interface circuits 15 and relay modules 30, 30a may be provided in a defined geographic space (for example, on an individual floor or within a region of a floor in a multi-floor home or care facility).

Referring to FIGS. 3A-3D, block diagrams illustrating components of embodiments of a relay module 30a are shown. The relay module 30a of FIG. 3A includes a first transceiver 31 for wirelessly communicating with interface circuits 15 and other relay modules 30, 30a in the WLAN or WPAN network 16 of FIG. 2A via an antenna 31a. A transceiver as contemplated in this description may include a receiver and/or transmitter. The relay module 30a further includes a second transceiver 32 for wirelessly communicating with the access point 40 over the WWAN via an antenna 32a. Each of the transceivers 31, 32 is in communication with a data processing circuit 33, which is configured to operate under the control of a processor 34 to accept data received by the transceivers 31, 32 and store the received data in a buffer element 35. One or more of the data processing circuit 33 and/or controller 34 may also preferably include commercially available encryption circuitry for encrypting data to be sent by the transceivers 31, 32 and to decrypt data received by the transceivers 31, 32, in accordance for example with HIPAA requirements.

Each rely module 30, 30a is capable of communicating with a number of medical devices 10 over a period of time. It is possible that communications with some of the medical devices 10 are more time-critical with regard to patient safety than other. For example, consider communications with medical devices 10 including each of a thermometer, a feeding pump and a ventilator. In this case, communications with the ventilator would likely be most time-critical among the three medical devices, while communications with the thermometer might be least time-critical among the three medical devices.

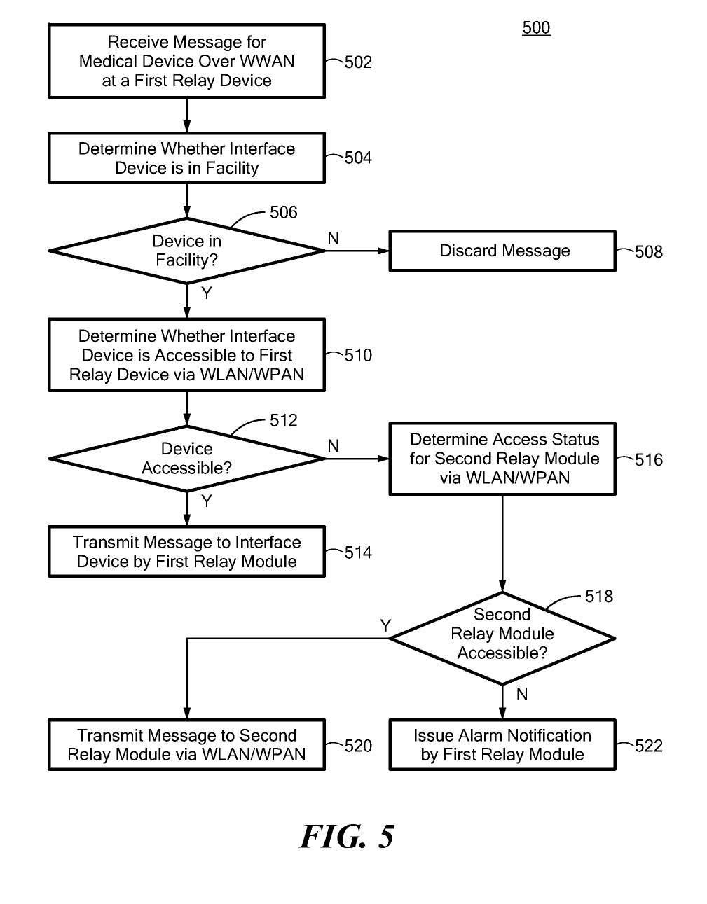

According to an embodiment, the processor 34 is configured to determine whether the received medical device data indicates an emergency condition. This determination may be performed by the processor 34 in a number of ways. For example, the processor 34 may compare a condition code in the received medical device data to a condition table located in memory 35b that, for example, includes one or more of corresponding codes for the emergency condition, a description of the emergency condition, symptoms of the emergency condition, an estimate of a future time at which the emergency condition may become harmful (or emergency condition harm time), rankings and/or weights for the emergency condition, related emergency conditions, physiological data (e.g., vital signs, blood pressure, pulse oximetry, ECG, temperature, glucose levels, respiration rate, weight, etc.) indicative of the medical condition, and so on. One form of the possible table is described with reference to FIG. 5C, which will be discussed below.

The data in the condition table may be initially entered and/or periodically refreshed from a master store or central repository of emergency condition data, for example, maintained by a designated relay module 30, 30a or other device accessible over one of the available networks. Associated emergency condition data may be periodically transmitted on a scheduled or as-needed basis, for example, from the access point 40 to each of the relay modules 30, 30a. Additionally, polling may be carried out, for example, by the central repository to determine whether any of the relay modules has been provided with emergency condition data not available in the central repository. This emergency condition data may then periodically be transmitted to the central repository, and the central repository may in turn transmit the data to the other modules that may be missing such data. In this way, the exchange of information between the central repository and the relay modules is bidirectional, thus ensuring all modules and the central repository are synchronized with the same emergency condition data. To avoid conflicts, emergency condition data may be time stamped or provided with another indicator of data currency. If a central repository is not used, the modules may exchange emergency condition information between themselves to ensure each module is synchronized. Other embodiments are possible, for example, using multiple central repositories according to conditions monitored, geographic location, and the like.

According to one embodiment, rankings and/or weights may be applied by the processor 34 to assign priority to different emergency conditions and/or perform a triage. For example, the processor 34 on receipt of multiple pieces of medical device data from different transceivers located in the same geographic location or a number of different geographic locations could determine that one medical device requires more immediate medical attention than the others. The priority analysis may also be performed, for example, using the emergency condition harm times.

For example, consider a data packet from a ventilator indicating disconnection from a comatose patient, with possible fatality. In this case, the ventilator should be assigned priority for transmitting to one or more of remote monitoring devices 61, 62 and 63 (as shown in FIG. 1A), while data transmissions from thermometer and pump are discontinued until a response to the data packet transmitted by the ventilator is received from one of the remote monitoring devices 61, 62 and 63. For example, the ventilator might be assigned a priority of 1, while the feeding pump is assigned a priority of 2 and the thermometer is assigned a priority of 3. The assigned priority is preferably indicated in each data packet transmitted by and to the medical devices, for example, as a “priority nibble.”

With reference to FIGS. 3 and 3A-3D, the processor 34 may be configured to read the priority nibble from each received data packet, and to instruct the data processing circuit 33 to place the data packet at a logical position in the buffer element 35 based upon the priority designation. For example, critical-priority data packets (for example, data packets including an indication of a life threatening condition) for the ventilator would be positioned for first retrieval and transmission by the relay module 30, 30a, and other data packets are positioned in order according to their priority.

In addition, under circumstances where urgent commands may need to be transmitted by one of the remote monitoring devices 61, 62 and 63 anticipated based on an urgent data packet (for example, a data packet including an alarm) from the ventilator, the wireless relay module 30, 30a may in addition discontinue reception of any new medical device information from other medical devices until the urgent commands are relayed and an associated alarm condition has been terminated or released.

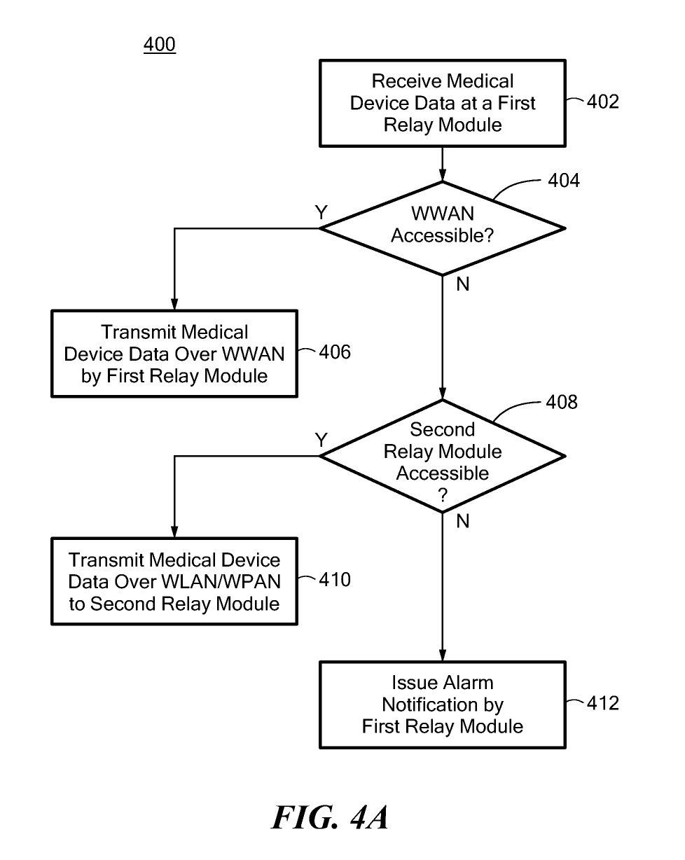

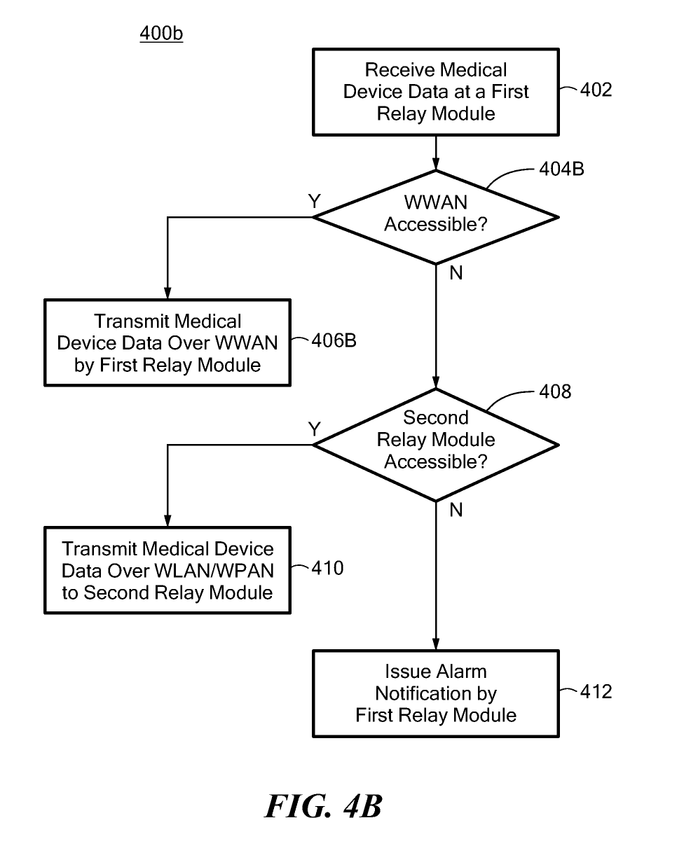

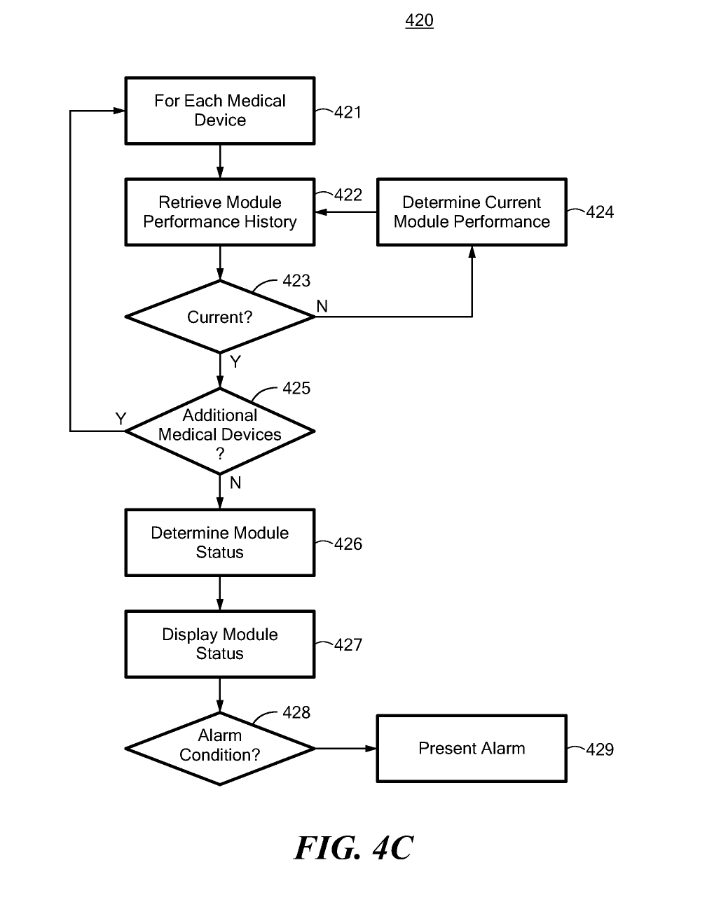

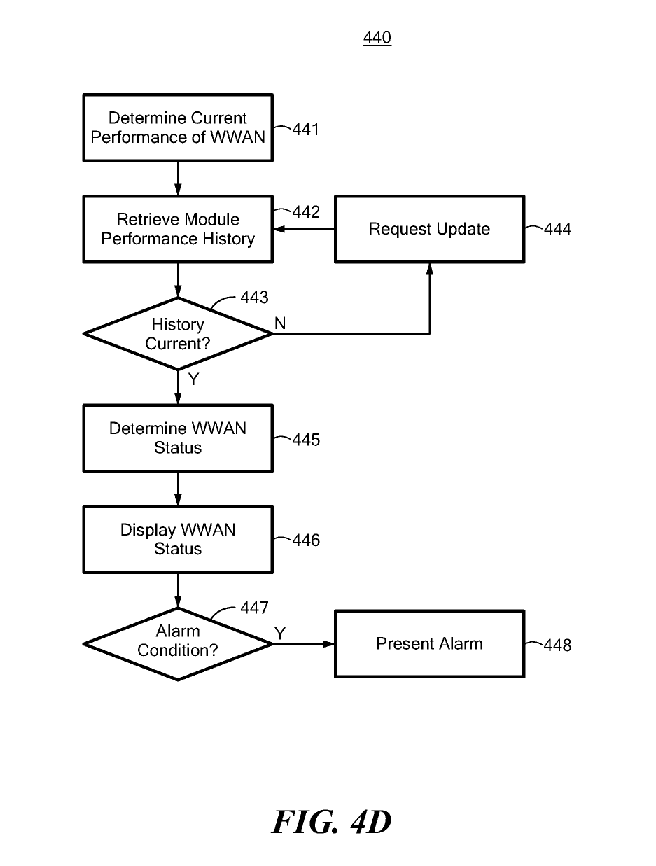

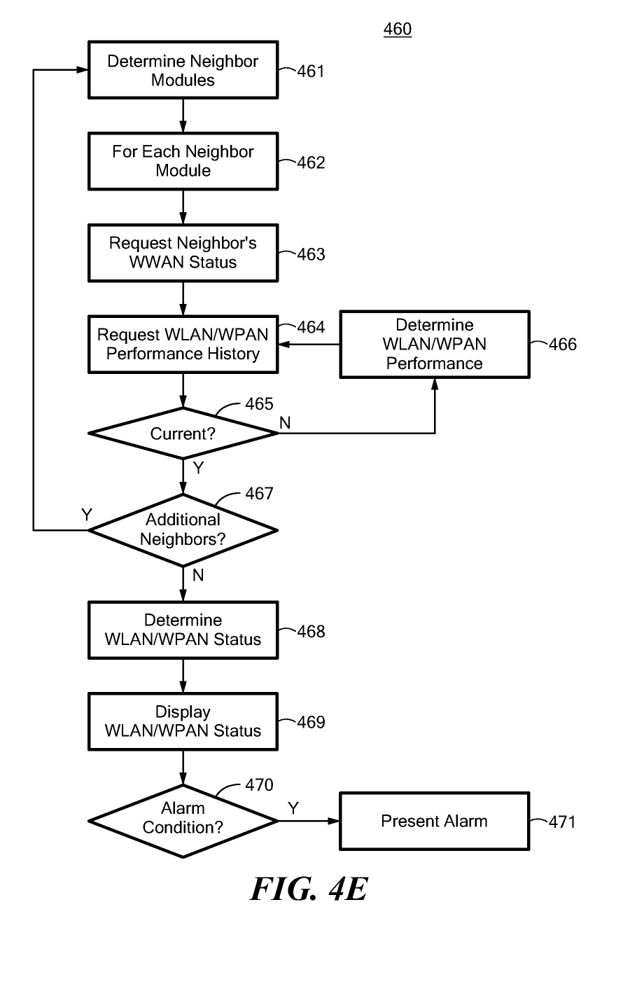

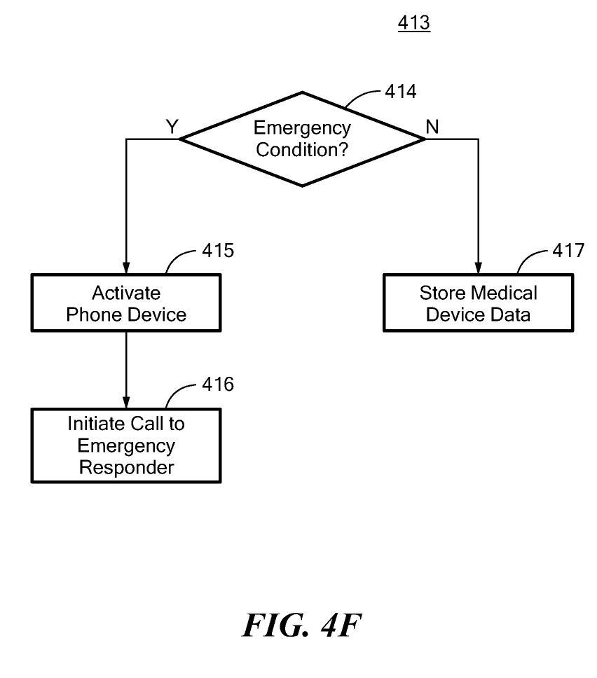

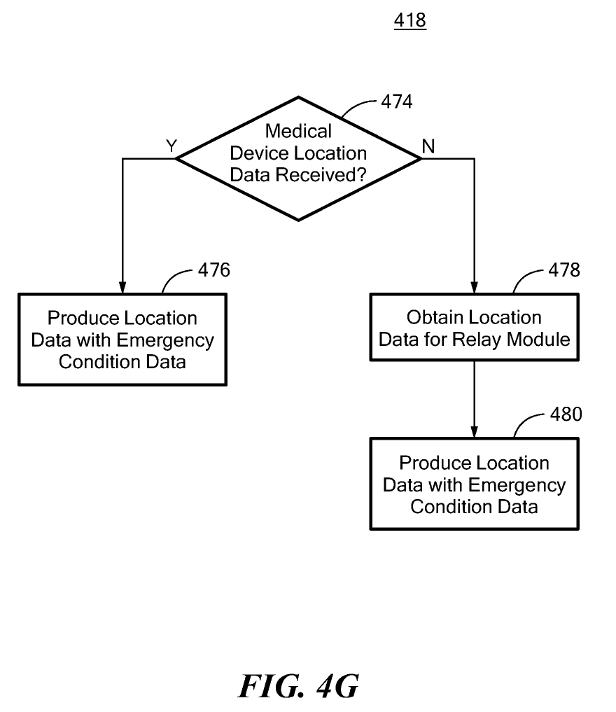

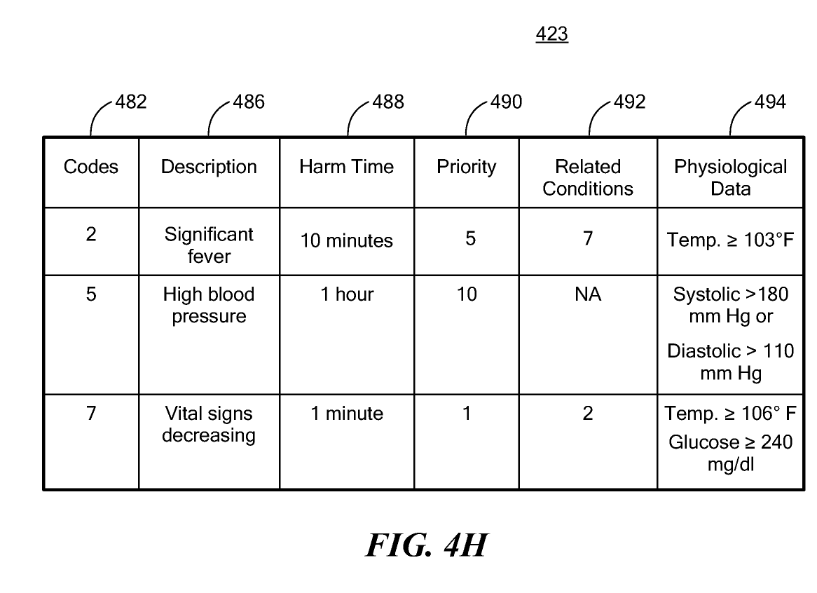

In one embodiment, it is possible that the medical device data analyzed by the processor 34 may not match any of the emergency conditions in the table and/or database because there is a misspelling and/or the medical condition is known by other names and/or represents a new medical condition. In this scenario, the processor 34 may, for example, perform a similarity analysis between the medical device data received and the symptoms and/or physiological data in the table and/or database (see, e.g., the disclosure herein supra in reference to FIG. 4c). Based on this similarity analysis, the processor 34 may select, if any, the emergency condition that closely approximates the medical device data. Also, the processor 34 may in addition or alternatively log the medical device data to a database and/or file to allow administrators to determine why the emergency condition did not match an exact emergency condition in the table and/or database.

According to another embodiment, in order to make processing more efficient, the processor 34 may compare the medical device data received at the transceiver to a list of prior determined emergency conditions and determine if there is a match or approximate match based on conventional interpolation and/or extrapolation techniques. In another embodiment, the processor 34 may also parse the medical device data to find a code which indicates that an emergency condition exists. Alternatively, the processor 34 may search a table and/or database located in a central repository to determine if the medical device data received indicates an emergency condition. In a another embodiment, the processor 34 in a relay module 30 and/or 30a may query a processor 34 in another device (not the central repository) to determine if that other device knows whether the medical device data includes emergency condition data representing an emergency condition.

Once an emergency condition is determined and an alarm condition is activated by the processor 34 of the relay module 30a, a message may be transmitted to an access point 40 by the relay module 30a (as shown in FIGS. 1 and 2), where the message is parsed to determine if alarms should be activated. The alarms could be anything from certain signals to care givers associated with the one or more medical devices which originated the alarms or alerting emergency responders.

A monitoring unit 37b (see e.g. FIG. 3B) may also be associated with the processor 34, and responsible for identifying trends in emergency conditions. The monitoring unit 37b may store the emergency conditions data received, the date/time, an identity of the medical device which provided the data, the location of the medical device, and so on. Using the emergency condition data and/or additional medical device data, the monitoring unit 37b may analyze the data for trends. This trend information may be used, for example, to determine whether one or more medical devices should be monitored. In addition, the trend information may be communicated to one or more devices (for example, PDAs, cell phones, pager, tablets, and the like) associated with relatives, friends, or caregivers and the like, who may use the knowledge to provide more efficient care.

Upon making a determination that an emergency condition exists, the processor 34 may transmit a message to a phone device 39a (discussed below and shown in FIG. 3D) to activate it and also initiate a connection (e.g., phone call, etc.) with an emergency responder, such as 911, relatives/friends, care givers, or police authorities, and the like. When a call is received by the emergency responder, an automated voice message may be transmitted to the emergency responder as a prerecorded message stored in a signal generator 39b (which is coupled to the phone device 39a and the processor 34). Preferably, the prerecorded message identifies an associated medical condition along with the location of the medical device. Alternatively, the signal generator 39b may generate a dynamic speech signal that contains the determined emergency condition and other information

The prerecorded or dynamic message described above may in addition include other relevant patient data to further allow the emergency responders to assess the situation. For example, a patient table stored at the relay module (or alternatively/in addition at the centralized location) may identify care givers of the patient, other present conditions of the patient, previous medical history (e.g., allergic to certain drugs, such as morphine), and additional relevant patient information. Preferably, storage and use of the data in the patient table would conform to HIPAA requirements. As an alternative to these voice messages, the signal generator 39b may transmit medical condition information in the form of a text message to the emergency responder. For example, a text message may be sent over one of a Short Message Service (also known as “SMS”) and/or Multimedia Messaging Service (also known as “MMS”).

The phone device 39a above could be connected via one or more of wireless relay network or internet-accessible wireless network to initiate the call over a voice over internet protocol (VoIP) network, a Public Switched Telephone Network (PSTN), or the like.

The call to the emergency responders may be unsuccessful for a variety of reasons (for example, associated E911 circuits may be busy or otherwise unavailable). In this situation, the processor 34 and/or phone device 39a may detect a non-response from the E911 circuits and transmit a non-response message to one or more of the medical device, the access point 40, and/or one or more other designated devices to indicate the unsuccessful call. In addition, the processor 34 may periodically perform self-diagnostics on the relay module 30a to confirm that each of the components of the modules 30a that is used to detect the emergency condition and make the emergency call is operational Of course while a single processor 34 is described, multiple processors 34 may be used in as appropriate.

The location of the medical device may be determined in a variety of ways well-known in the art. For example, location information may be provided to the processor 34 from a global positioning system signal (“GPS”) that is received and interpreted by the medical device located in the medical device data received, a GPS chip in the location device 38 (see e.g. FIGS. 3B and 3C), and/or location algorithm in the location device 38 discussed further below. In another embodiment, (e.g., location) as discussed above.

As discussed above, location information may be included in the medical condition data received by one of the relay modules 30, 30a to identify the location of the one or medical devices 10. Alternatively, the relay modules' location may also be determined using a conventional GPS receiver provided in the location device 38. In the latter case, at least an approximate or “zone” location of the one or more medical devices would be provided by the location information for the relay module 30a.

As an alternative to GPS-based location, each of the relay modules 30a may for example transmit and receive signals via the internet-accessible wireless communication network to two or more cell towers, beacons or other radio devices at fixed, known locations in order to determine a location of the relay module according to known geometric methods. Such techniques for determining location (for example, including triangulation form cell towers) are well known in the art. See, e.g., Shu Wang et at Location-Based Technologies for Mobiles: Technologies and Standards, presentation at IEEE ICC Beijing 2008, IEEE, 2008, which is incorporated by reference herein in its entirety, for all purposes. In one embodiment, triangulation may be carried out using other relay modules positioned at fixed, known locations in a facility.

The data processing circuit 33 may be further configured to retrieve data from the buffer element 35a under the direction of the processor 34 and provide the retrieved data to a selected one of the transceiver 31 or transceiver 32 for transmission. In order to make a selection, the processor 34 is configured to communicate with respective status modules 31b, 32b of the transceivers 31, 32 in order to determine a communications status of each of the transceivers 31, 32.

FIG. 3B depicts a block diagram illustrating components of an alternative configuration for the relay module 30a to the configuration of relay module 30a depicted in FIG. 3A. The relay module 30a shown in FIG. 3B may be the same as or similar to the relay module 30a shown in FIG. 3A. For example, transceivers 31 and 32, data processing circuit 33 and processor 34 may be the same or similar in both figures. The relay module 30a includes transceiver 31 for wirelessly communicating with interface circuits 15 (shown in FIGS. 1 and 2) and other relay modules 30, 30a in a particular WLAN or WPAN network 16 (shown in FIG. 2A) via antenna 31a. The relay module 30a further includes a transceiver 32 for wirelessly communicating with the access point 40 over a particular WWAN (shown in FIG. 2A) via an antenna 32a.

Added components to the relay module 30a in 3B that are not present in FIG. 3A include an additional transceiver 37, similar to transceiver 31, for wirelessly communicating via antenna 37a with interface circuits and other relay modules capable of communicating over a different WLAN or WPAN network than the network used by transceiver 31. Correspondingly, the relay module 30a in FIG. 3A includes yet a further transceiver 38, similar to transceiver 32, for wirelessly communicating via antenna 38a with an access point over a different WWAN than the WWAN used by transceiver 32.

Each of the transceivers 31, 32, 37 and 38 is in communication with data processing circuit 33, which is configured to operate under the control of processor 34 to accept data received by the transceivers 31, 32, 37 and 38 and store the received data in buffer element 35. In addition, the data processing circuit 33 is further configured to retrieve data from buffer element 35 under the direction of processor 34 and provide the retrieved data to a selected one of the transceivers 31, 32, 37 or 38 for transmission. Further embodiments can for example involve one or more processors 34 configured to accept medical device data from mesh network 16 and to send the medical device data through the WWAN without storing the medical device data in the relay module 30a. In order to make a selection, the processor 34 is configured to communicate with respective status modules 31b, 32b, 37b and 38b of respective transceivers 31, 32, 37 or 38 in order to determine a communications status of the transceivers 31, 32, 37 or 38. It should be understood that the data processing circuit 3 and processor 34 may be implemented as separate integrated circuits or chip sets or their functions may be combined and implemented on single integrated circuits or chip set

The processor 34 is also preferably in communication with an input/output circuit 36, which provides signals to one or more display elements of the relay module 30a, for example, for indicating a start-up or current status of the relay module 30a, including communication or connection status with the WLAN or WPAN networks and WWANs networks. Input/output circuit 36 may also be configured to provide signals to indicate an A/C power loss, and or to be responsive to signals provided by one or more input devices provided in proximity to the one or more display elements.

A control panel useable for the module 30a of FIG. 3B may be substantially similar to the control panel 380 depicted in FIG. 3H with corresponding multiple indicators 380e for indicating the status of the different WLAN or WPAN networks, and/or multiple indicators 380j for indicating the status of the different WWANs. The control panel 380 may include a synchronization switch 380k (shown in FIG. 3I), which may be used as further described herein to initiate a process for associating patient identification information with identification information of a medical device 10.

The processor 34 is also preferably in communication with a memory 35b for storing an operating program of the processor 34 and/or data stored by and/or retrieved by the processor 34. The processor 34 is also in communication with an input/output circuit 36, which provides signals to one or more display elements (not shown) of the relay module 30a, for example, for indicating a start-up or current status of the relay module 30a, including communication or connection status with the WLAN or WPAN network 16 and WWAN. The input/output circuit 37a may also be configured to provide signals to indicate an A/C power loss, and or to be responsive to signals provided by one or more input devices provided in proximity to the one or more display elements. The input/output circuit 37a may also be connected to user buttons, dials or input mechanisms and devices of module 30a. The input/output circuit 37a is further usable for providing alarm signals to indicate, for example, A/C power loss or loss of accessibility to the WWAN.

Relay module 30a may preferably be provided as a small physical enclosure with an integral power plug and power supply circuit, such that the relay module 30a may be directly plugged into and supported by a conventional wall outlet providing commercial A/C power. Relay module 30a may also preferably include a battery back-up circuit (not shown) to provide uninterrupted power in the event of A/C power outage, an A/C power outage of short duration as well as for ambulatory use of the relay module. Alternatively, relay module 30a may be provided with rechargeable and/or replaceable battery power as a primary power source for ambulatory use. It should be readily understood by one skilled in the art that processor 34 and devices 37a-39b are shown as separate and distinct devices in FIG. 3 for illustration purposes only and that the functionality of devices 34 and 37a-39b may be combined into a single or larger or smaller number of devices than illustrated.

Battery back-up may also be advantageous, for example, for using the relay module 30a in an ambulatory mode that enables the patient to move within and potentially at a distance from the facility 20, for example, with a medical device 10 that is a portable feeding device. Alternatively, if a non-ambulatory patient needs to be moved from one room to another, moved into surgery or into an x-ray room for example, the medical device may travel with the patient. In this configuration, for example, the medical device 10, the interface circuit 15 and relay module 30 may be conveniently carried in a mobile platform such as any patient-wearable backpack, vehicle, or other transport vessel. As the medical device 10 and interface circuit 15 move through the facility, the medical device may establish network connections with other medical devices and/or relay modules in proximity with medical device 10, according to the mesh network protocols. Thus, as the patient is moved through the facility, the medical device 10 can remain in communication with the network (e.g. network 16), the remote monitoring stations, or any other networked device, computer, or server that can communication with the medical devices and relay modules in network 16.

The relay module 30a configuration of FIG. 3B may be operated in a substantially similar manner to the relay module 30a configuration of FIG. 3A employing, for example, corresponding methods of operation described below incorporating the use of a plurality of WWANs or WLAN or WPAN networks. However, in performing methods of operation for the relay module 30a of FIG. 3A, the depicted steps described with respect the flow diagrams below may be employed with the further transceiver selections of the additional transceivers 37 and 38.

FIG. 3C depicts a block diagram of an embodiment of a relay module 30a that enables voice communication and interaction between a caregiver proximate the relay module 30a and a clinician or technician at the remote monitoring device. The identical components in the FIGS. 3A, 3B, and 3C are like numbered including, for example, the first and second transceivers 31 and 32, data processing circuit 33, processor 34 and data buffer 35a. The relay module 30a of FIG. 3C further includes a speech codec 105 connected to a microphone 110 and the speaker 37.

The particular type or brand of speech codec selected for the codec 105 is not necessarily critical as long as it is compatible and/or interoperable with the speech codec of the corresponding remote monitoring device. Suitable codecs for the speech codec 105 include, for example, fixed rate codecs such as voice-over-Internet-protocol (VoIP) codecs in compliance with the ITU standard H.323 recommended protocol. Speech coding standards in accordance with VoIP include ITU standards G.711 (PCM), G.723.1 (MP-MLQ & ACELP), G.729 (CSACELP), GSM-FR; or Adaptable Multi-Rate (AMR) standards such the European Telecommunication Standard Institute (ETSI) and Third Generation Partnership Project (3GPP) IMT-2000. Alternatively, it is possible to employ codecs useable for transmitting encoded speech signals over a mobile telephone network.

The configuration of the relay module 30a of FIG. 3C enables a patient or caregiver proximate the relay module 30a to engage in a conversation with a user (for example, a clinician or technician) proximate the remote monitoring device using, for example, a VoIP or VoIP-like exchange of encoded speech signals. Specifically, in operation of the relay module 30a of FIG. 3C, speech uttered by the caregiver proximate the relay module 30a is converted by microphone 110 to analog speech signals that are digitized and encoded by the codec 105. The processor 34 then transmits the corresponding digitized and encoded speech signals produced by the codec 105 directly over the wireless internet-accessible network alone or in combination with the wireless relay module network to the remote monitoring device. The remote monitoring device then decodes the digitized and encoded speech signals and converts such decoded signals into analog signals supplied to a speaker to generate the speech sounds heard by the clinician or technician.

Conversely, digitized and encoded speech signals representing speech of the clinician or technician transmitted by the remote monitoring device are received by the module 30a wherein the processor 34 supplies such signals to the codec 105 which decodes the signals and converts the decoded signals to analog signals that are supplied to the speaker 37.

Although the implementation of the codec 105 and microphone 110 has been described with regard to exchanging VoIP signals, it should be readily understood that any method of communicating speech signals may be employed including, for example, utilizing a cellular or mobile telephone codec or modem for codec 105 to transmit and receive speech signals, e.g., CDMA- or GSM-compliant speech signals over a mobile telephone network. Further, it is possible for the codec 105 to be implemented as hardware and/or software in a single chip, chip set or as part of the processor 34.

In an alternative embodiment, it is possible to implement speech detection and/or recognition functionality into the codec 105 or processor 34 to enable the relay module 30a to identify specific command words to initiate the carrying out of a corresponding responsive/interactive action. For example, such speech recognition functionality may be triggered by processing signals supplied by the microphone 110 to identify terms “Help”, “Emergency” or “Call 911.” Upon detecting such trigger terms, the processor 34 initiates the process of dialing an emergency response service such as “911,” with or without using synthesized or recorded speech to request confirmation from the caregiver to place such a call and initiate communication between the caregiver and the emergency response service. The dialing may be performed by hardware or software implemented in the processor 34, codec 105 or other components coupled to the processor 34. The speech recognition functionality may alternatively or additionally transmit a text message or other text or audio-visual correspondence to the emergency response service based upon identified spoken works or commands by the caregiver.

It should be readily understood that the relay module 30a of FIG. 3C is shown with the codec 105 and microphone 110 in combination with the display 37 for illustration purposes only. It is possible to implement a relay module with the codec without a display or a relay module with a display and not a codec (as depicted in FIG. 3).

Referring also to FIG. 3D, alternatively or in addition, the processor 34 may instruct the location device 39a to obtain location information of the wireless relay module, and compare this to location information obtained from the medical device and/or by other means (for example, by using a conventional triangulation algorithm measuring transit times of signals transmitted by the medical device 10 to several wireless relay modules 30a with known locations) in order to determine whether the medical device 10 (for example, in the possession of an ambulatory patient) has moved outside of an area for safe communications with the relay module 30a (i.e., is outside the “geo-fence”).

In this case, the processor 34 may preferably transmit a “lost device” alarm message via at least one of the transceivers 31, 32 to the access point 40 and/or to any other Internet-accessible and/or wireless network-accessible recipients. In addition, in order to conserve power and or bandwidth of the wireless relay module 30a, the processor 34 may suspend all other measurements made to determine communications health with the medical device 10 (for example, heartbeat requests and signal quality measurements) until it has been determined that the medical device 10 is back within the geo-fence.

One of ordinary skill in the art will also readily understand that the elements used by the wireless relay module 30a to determine whether communications with a particular medical device 10 can be transmitted and/or received over the wireless relay network may be replicated in the medical device 10, such that the medical device 10 may determine whether communications with a particular wireless relay module 301 can be carried out over the wireless relay network, and to issue a visual and/or audible alarm at the medical device 10 when communications with the wireless relay module 30a cannot be carried out. This feature would be particularly useful, for example, to a patient in an ambulatory setting as a means for learning that he/she has exited the geo-fence.

It is possible for the relay module 30 to have a substantially similar configuration as the relay module 30a but excluding the transceiver for communicating over the WWAN with the access point 40.

The relay module 30a of FIG. 3D further preferably includes a location device 39a including, for example, a conventional global positioning system signal (“GPS”) chip for determining a GPS location of the relay module 30a. In addition, the relay module 30a of FIG. 3 includes a power monitoring device 39b for monitoring a voltage level of a external AC power source (not shown) providing power to the relay module 30a, and a secondary power source 39c comprising for example non-rechargeable lead-acid batteries, rechargeable lithium-ion batteries or other conventional rechargeable energy storage devices for providing a secondary power source to the relay module 30a, or a primary power source in the event of a failure of the external AC power source. Alternatively and/or additionally, the power monitoring device may for example monitor a sensor for detecting a disconnection of the external AC power supply by mechanical means (for example, using a spring-loaded push-pin switch that disengages when an associated AC plug of the relay module 30,30a is removed from an external AC receptacle), by electronic means (for example, using an inductive sensor incorporated in proximity to the AC power plug) and the like.

The processor 34 may be a single dedicated processor, a single shared processor, or a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be implemented in one or more configurations.

In an embodiment, the medical device data received by one of the transceivers 31, 32 from the one or more medical devices 10 may include, for example, information indicative of an alarm condition. In addition to the types of medical device data previously provided herein, the received information may include, for example, at least one of medical device description, medical device identification (e.g., unique device number), medical device location (e.g., device/patient room number), patient identification (e.g., patient identification number), alarm type, alarm error code, and/or alarm severity. Methods in which an alarm condition may be determined include predetermined codes, look-up table(s) and or algorithms for identifying alarm conditions based on processing the received information.

In addition to information indicative of an alarm condition contained in the medical device data received from one or more medical devices 10, it is also possible to receive the alarm indication from another relay module and/or as a result of an indication internally generated in the relay module 30a itself. For example, the relay module 30a could receive such information from another relay module when the other relay module malfunctions. In this way, it is assured that the relay module 30a provides the necessary redundancy for another relay module. Additionally, it is further possible for such information to be transmitted to the relay module 30a from the other relay module when the information is indicative of a high severity alarm condition, e.g., a significant medical emergency, such as emergency 911. Such redundancy will enable a sufficient number of caregivers to be notified of the emergency condition through multiple relay modules to facilitate a prompt response.

In another implementation, the relay module 30a may be notified if another relay module is experiencing numerous alert conditions associated with other modules or medical devices and communicate the alarm information to caregivers. If this occurs, the other relay module may, for example, divert the information indicative of an alarm to the relay module 30a using the WLAN or WPAN 16. The particular relay module 30a selected to receive the alarm information from the other relay module may be based on many factors such as, for example, relay module location, relay module availability, number of caregivers at a given location and/or floor, defined master/slave relationships among the relay modules 30a, and the like.

In another embodiment, it is possible that the information indicative of an alarm condition is received at the relay module 30a, but for some reason, such as a malfunction and/or data transmission bottleneck, the alarm is not communicated audibly and/or visually to the caregivers. To prevent this occurrence, the relay module 30a can be configured to transmit a message back to the one or more medical devices 10 confirming that an alarm was presented to the caregiver. If the message is not received within a predetermined amount of time by the one or more medical devices 10, then one or more medical devices 10 may attempt to communicate with other relay modules to ensure the alarm is addressed. Similar factors, e.g., location, availability, number of caregivers, etc., as described above may be used to select the other relay module(s) for providing alerts for the one or more medical devices.

In a further embodiment, the relay module 30a may internally generate its own alarm and/or device signals in relation to the relay module 30a, for example, the current status of the relay module 30a (e.g., external AC power loss) and/or current communication or connection status (e.g., status with the WLAN or WPAN 16 or WWAN).

After identifying that received data is indicative of an alarm condition, the processor 34 may transmit a message containing alarm information including, for example, at least one of medical device description, medical device identification, medical device location, patient identification, alarm type, alarm error code, and/or alarm severity, to a display 36 attached to the relay module 30a. In this way, an alarm alert may mirror an alarm alert emitted by the originating medical device. The particular type of display chosen for use with the relay module 30a is not necessarily critical. Accordingly, it is possible for display 36 to be a monochrome or color dot matrix, LCD, LED or other display device. Alternatively and/or in addition, the processor 34 may transmit the message containing alarm information to a medical device 10 via the transceiver 31, and/or to the access point 40 via the transceiver 32.

In addition, the processor 34 may also employ a speaker 37, such as a loudspeaker, coupled to the relay module 30a to emit an audible alert indicative of the alarm condition. It is possible for the audible alert based on the alarm condition to be at least one of volume, pitch, tone, type, audible sequence or duty cycle, or recorded sound to indicate the type, urgency or severity of the alarm condition. It is advantageous for an alarm indicating a life-threatening emergency to be more attention-getting, e.g., loud siren, than alarms for less significant conditions that may be addressed by, for example, beeps or calmer tones.

It is also possible for the emitted audible alerts to be spoken words, commands, tones or other sounds. In this way, if the alert emitted from the one or more medical devices 10 is not directly addressed, then the relay module 30a alarm sounds should alert any caregivers located outside of the patient's room. The processor 34 may also cause a signal to be transmitted by, for example, the first transceiver 31 over the WLAN or WPAN 16 to one or more devices including, for example, PDAs, cell phones, pagers, and tablets. In addition, the alarm information may be transmitted over the WWAN using the second transceiver 32 to the one or more devices.

In addition, an input/output circuit 38 may be electrically connected to, for example, user-actuatable buttons, dials or input mechanisms associated with the relay module 30a. Using these buttons, dials, or input mechanisms, the audible alerts produced by the relay module 30a may be muted, i.e., disabled, or volumes substantially reduced. The muting or volume reduction may alternatively be in response to the relay module 30a receiving a signal from the originating medical device transmitting the information, such as in response to a caregiver acknowledging that the emergency condition is being addressed by entering the proper inputs to the originating medical device. Such acknowledgements may preferably take the form of corresponding acknowledgement codes each associated with a particular alarm condition. Even with the audible alerts muted or otherwise disabled, it may be advantageous to continue displaying the alerts on the display 36. The display 36 may continue to display alerts until likewise the alert condition is extinguished or confirmation from a caregiver at the originating medical device or the relay module 30a is received.

In accordance with another embodiment, the processor 34 may control the display 36 to alternate or cycle displayed information intermittently with information from a single medical device or multiple medical devices. For instance, the processor 34 may cause a visual alarm alert indicating an alarm condition (based upon a portion of medical device data) from a first medical device to be shown on the display 36, for example, for a time period of between 2 to 30 seconds before displaying information for another medical device. The visual alarm alerts corresponding to higher severity alarm conditions may be shown for longer durations than alerts of for lower severity alarm conditions. Also, the type of alarm condition may further dictate the display length of time for visual alarm alerts or other information from a particular medical device. Additionally, the processor 34 may also or alternatively display on the display 36 the number of medical devices communicating information indicative of alarm conditions to the relay module 30a and/or show a description of such devices.

In addition, it is possible for the display 36 to display the alerts in different foreground or backlight colors, such as green backlight for normal operation or red backlight for alarm situations, to use color representing the respective severities of alarm conditions. It is further possible for the colors to correspond to specific alarm conditions (e.g., low glucose level) and/or general groups of conditions (e.g., heart conditions). The display may alternatively or in addition incorporate, for example, a multi-colored light-emitting diode array to display the status of the medical devices.

The display 36 may also be used to display non-alarm related information including, for example, internal power supply charge level or status, software version, software download status, relay module network status, handshake status and signal strength of the received WLAN or WPAN 16, and/or WWAN signals. Displayed information for the strength of respective monitored signals and other may be displayed alone or in a combination with the alerts. The signal strength information could be depicted by, for example, by sequential display segments such as, for example, more than one series of different sized light-emitting diodes (LEDs) that would advantageously enable simultaneous display of at least two different network signal strengths for viewing by the caregiver.

As with the display of externally generated information indicative of alarm conditions, it is possible for alerts for internally generated information indicative of an alarm condition by the relay module 30a to also be displayed by display 36. For example, alerts representative of information during start-up or current status of the relay module 30a and/or current communication or connection status with the WLAN or WPAN 16 and WWAN may be shown on the display elements 36. In another embodiment, the processor 34 may cause the display 36 to include information associated with the charge level of a battery (not shown) contained within the relay module 30a, whether by remaining minutes and/or hours of life or other graphical depictions.

Relay module 30a may preferably be provided as a small physical enclosure (not shown) optionally provided with an integral power plug and power supply circuit, such that the relay module 30a may be directly plugged into and supported by a conventional wall outlet providing commercial A/C power. Relay module 30a may also preferably include a battery back-up circuit (not shown) to provide uninterrupted power in the event of A/C power outage of short duration. Battery back-up may also be advantageous, for example, for using the relay module 30a in an ambulatory mode that enables the patient to move within and potentially at a distance from the facility 20, for example, with a medical device 10 that is a portable feeding device. In this configuration, for example, the medical device 10, the interface circuit 15 and relay module 30 may be conveniently carried in a patient-wearable backpack.

Various embodiments of a wireless relay module 30 or 30a (also sometimes referred to herein more simply as a “relay module” or as “relay device”) are shown in FIGS. 3A-3D. However, the relay modules 30 or 30a is not limited to the specific configurations shown. For example, a relay module 30 30a may include some or all of the components or features described with respect to any or all of FIGS. 3A, 3B, 3C, and 3D. A relay module 30 or 30a may also include additional features not shown in the figures.

FIGS. 3E-3G respectively illustrate top, front and side views of a configuration 370 for the relay module 30a. Configuration 370 includes a housing 370a, which is shown in FIGS. 3E-3H configured essentially as a rectangular box or prism. It should however be noted that the housing may alternatively be configured in any of a variety of three-dimensional shapes having a sufficient interior volume for housing the associated circuits, having a sufficient area 370c on a front panel 370b of the housing 370a for locating a control panel 380 (as further illustrated in FIG. 3H), and having a sufficient area on a rear panel 370d for providing a receptacle support 370e and power plug 370f for supportably plugging the module configuration 370 into a conventional power outlet. The power plug 370f may also be provided in a modular and replaceably removable configuration enabling power plugs 370f to be configured according to a variety of international standards to be easily provided to the configuration 370.

FIG. 3H illustrates a control panel 380 of module configuration 370 that may constitute a portion of the one or more display elements. The control panel 380 preferably includes, for example, a power switch 380a for powering and/or de-powering the module configuration 370 after it has been plugged into the conventional wall outlet or equipped with a charged battery back-up subsystem. In addition, the control panel 380 preferably includes an alarm switch 380b which allows a user to mute and/or de-mute an audible alarm (for example, a conventional buzzer, not shown) which is coupled to an alarm circuit (not shown) that is configured to issue an alarm when A/C power to the module configuration 370 has been interrupted. The control panel 380 also includes an A/C power indicator 380c which may preferably be provided as one or more light-emitting diode (LED) indicator segments which are activated when A/C power has been provided to the module configuration 370. Optionally, the indicator 380c may be intermittently activated when A/C power is lost (for example, by means of back-up battery power) to signal the loss of A/C power.

The control panel 380 of FIG. 3H also includes a battery indicator 380d to indicate a status of the subsystem battery back-up circuit. For example, and as illustrated in FIG. 3H, the battery indicator 380d may preferably include indicator segments 380h which may be selectively activated to indicate a capacity of the back-up battery. Indicator segments 380h may also be preferably provided as LED segments, or as one or more multicolor LEDs for which color is indicative of capacity. If implemented as individual segments 380h, the segments 380h may, for example, be activated to indicate that the back-up battery is fully charged, and ones of the segments 380h may be progressively deactivated (for example, proceeding downwardly from an uppermost one of the segments 380h) as battery power is drawn down. In the event that remaining battery power is insufficient to operate the module configuration 370, each of the segments 380h may be deactivated. Alternatively, the indicator segments 380h may be provided as one or more multicolor LED segments (for example, red, yellow, and green). In operation, it is possible for all LED segments 380h to be illuminated as green indicating a full backup battery charge and then progressively, sequentially deactivated as battery charge levels are reduced to a first low power threshold. Then, the LED segments 380h may progressively, sequentially be illuminated red as power is further diminished so that all LED segments are illuminated red when battery power is no longer sufficient to power the module configuration 370.

As further illustrated in FIG. 3H, the control panel 380 may further include a relay module network indicator 380e to indicate a status of the portion of the WLAN or WPAN network 16. Similarly to the A/C power indicator 380c, used to provide communications between the WLAN/WPAN network relay module 30a and its associated interface circuits 15 and medical devices 10. This relay module network status indicator 380e is preferably backlit with one or more multi-color LEDs to indicate a relative “health” of the associated portion of the network (for example, using “green” to indicate a healthy (e.g., level of accessibility) network, “yellow” to indicate a network having one or more issues but still operable, and “red” to indicate a network that is inoperative and indicating an alarm condition). Optionally, the indicator element 380e may be intermittently or periodically activated when the WLAN/WPAN network portion of the WLAN or WPAN network 16 that provides communications between the relay module 30a and its associated interface circuits 15 and medical devices 10 has relatively poor communications between these devices, or is unavailable to support such communications. In addition, an audible alarm (for example, a conventional buzzer, bell or audible sound generator and associated loudspeaker, not shown) may be initiated under such conditions.

Indicator elements 380f may also be provided, for example, in an array to indicate the status is active or accessible, and either de-activated or intermittently activated when the WLAN/WPAN network status is inactive or inaccessible. The indicator elements may preferably be provided with multi-color LEDs 380g capable, for example, of illuminating a green segment for a healthy a communications path, a yellow segment for operative communication path with issues, and a red segment to indicate a communications path that is inoperative. Alternatively, individual red, yellow and green LEDS may be used in place of the multi-color LEDs.

A WWAN indicator 380j may preferably be provided to indicate a status of access to the WWAN network, (using, for example, “green” to indicate a healthy network, “yellow” to indicate a network having one or more issues but still operable, and “red” to indicate a network that is inoperative and indicating an alarm condition). As depicted in FIG. 3H, the indicator 380j includes indicator elements 380f, 380g for indicating the WWAN network status. In this configuration, for example, the indicator element 380f may be configured with a green LED indicator element that is activated when the WWAN network status is active or accessible, and the indicator 380g may be configured with a red LED indicator element that is activated when the WWAN network is inactive or inaccessible (for example, may preferably be backlit with one or more multicolor LEDs. Optionally, the indicator element 380j may be intermittently or periodically activated, for example, when a signal strength of the WWAN network available to the module configuration 370 is insufficient to support communications. Optionally, the indicator element 380f may be intermittently too low to support communications, or is unavailable to support such communications. In addition, the audible alarm may be initiated under such conditions.

Finally, the control panel may include a WLAN/WPAN indicator 380i to indicate an overall health of the entire WLAN/WPAN (or at least of the portion available to provide an alternate path for the relay module 30a to the WWAN network). The WLAN/WPAN indicator 380i may preferably indicate an overall status of the WLAN/WPAN (using “green” to indicate a healthy network, “yellow” to indicate a network having one or more issues but still operable, and “red” to indicate a network that is inoperative and indicating an alarm condition). As depicted in FIG. 3H, the indicator 380i may preferably be backlit with one or more multicolor LEDs. Optionally, the indicator element 380i may be intermittently or periodically activated when the signal strength of the WWANWLAN network is marginally sufficient, too low, or insufficient to support communications. In addition, the audible alarm may be initiated under such conditions.

As previously indicated, the alarm switch 380b may be configured to allow a user to mute and/or un-mute one or more of the audible alarms entirely, or for a specified time period (similarly to a conventional clock alarm “snooze function) indicators of the module configuration 370 such as indicators 380a-380j may preferably be electrically connected to the input-output circuit 36 depicted in FIG. 3A, for example.

In addition, it is possible for the wireless relay module 30a to employ, for example, hardware or software to implement an International Telecommunication Standardization Sector (ITU-T) H.323 codec to enable voice and/or video communications between a caregiver located proximate the wireless relay module and a remote technician. In such an embodiment, the wireless relay module control panel 38 may optionally include microphone and speaker elements (not shown) for enabling the module configuration 37 to be operated in a voice communication mode to allow for voice communication, for example, between an operator, caregiver, and/or a help desk technician in event of a trouble condition reported by one of the medical devices 10. Alternatively or in addition, the control panel 380 may include one or more of a camera element (not shown) and/or a display element (not shown) coupled to the codec to be operated in a visual communication mode. For example, the camera element may be used to transfer images from displays of one or more medical devices 10 to one of the remote monitoring devices 61, 62 and 63 of FIG. 1A.

FIG. 4A presents a flow diagram 400 illustrating a method of operation for the architecture according to FIG. 1A and relay module 30, 30a components of FIGS. 2 and 3A-3H, relating to the transmission of medical device data obtained from a medical device 10 to the access point 40. First, at step 402 of the method 400, the medical device data is received at a first one of the relay modules 30a from one of the interface circuits 15 and/or other relay modules 30, 30a over the wireless relay network 16. At step 404, the processor 34 of the one relay module 30a determines whether the WWAN is accessible by that relay module 30a.

The determination of step 404 may be carried out in a variety of manners. For example, the processor 34 may interrogate the status module 32b of the transceiver 32 at the time of or after the receipt of the medical device data to determine a status parameter indicative of access for the transceiver 32 to the WWAN (for example, access for transceiver 37 to the WWAN may be determined as the result of the transceiver 32 detecting an access signal of the WWAN having adequate signal strength for maintaining data communication at a desired quality level). Alternatively, the processor 34 may interrogate the status module 32b at a different time including, for example, at system start-up and/or periodically (for example, hourly), and maintain a status indicator such as in the buffer 35 or another storage element to be retrieved at the time of receipt of the medical device data. As yet another alternative, the relay module 30, 30a may be assigned a predetermined, fixed role within the network 16. For example, relay modules 30a in the network 16 may be assigned a data routing assignments by a controller or controlling relay module or modules which may be preselected from among the relay modules 30, 30a. By definition, the WWAN status for relay module 30 that does not possess WWAN access capability shall have a fixed status of “WWAN inaccessible.”

If, as provided for in step 404, the status module 32b indicates that the WWAN is accessible by the transceiver 32, the processor 34 will proceed to step 406 to instruct the data processing circuit 33 of the one relay module 30 (or 30a) to retrieve the medical device data from the buffer 35 or 35a (as necessary) and forward the medical device data to the transceiver 32 for transmission to the access point 40 over the WWAN.

Alternatively, in step 404, the status module 32b may indicate that the WWAN is not accessible by the transceiver 32. For example, if the one relay module 30a is located on a basement floor of the building in an area that is substantially shielded with respect to WWAN signals, the WWAN may not be accessible to the one relay module 30a. In this event, at step 408, the processor 34 determines whether a second relay module 30a is accessible via the WLAN or WPAN. Again, this determination may be made in a variety of manners including by instructing the transceiver 31 to send a handshake signal transmission directed to a second relay module 30a and to listen for a reply, or by retrieving a stored status indicator for the second relay module 30a.

If the second relay module 30a is accessible, then the processor 34 instructs the data processing circuit 33 of the one relay module 30a to retrieve the medical device data from the buffer 35 or 35a (as necessary) and forward the medical device data to the transceiver 31 for transmission to the second relay module 30a over the WLAN or WPAN at step 410. Alternatively, if the second relay module 30a is inaccessible in step 408, this portion of the process 400 may preferably be repeated to search for a further relay module 30a that is accessible. Alternatively, or in the event that no other relay module 30a is available, the processor 34 of the one relay module 30a may preferably issue an alarm notification at step 412. Such an alarm notification may, for example, include one or more of local visual and audio alarms as directed by processor 34 via the input/output circuit 36 of the one relay module 30a, alarm messages directed by the processor 34 to another accessible WPAN, WLAN or WWAN via one or more of the transceivers 31, 32, and/or alarm messages generated by the inbound web server 41 of the access point 40. These notifications may be displayed or otherwise executed after a specified time period has been exceeded, for example, during which a handshake signal of the relay module 30a is due but not received, at the inbound web server 41 from the wireless relay module 30a.

For example, FIG. 4B depicts a method of operation 400b for an embodiment of relay module 30a. Methods 400 and 400b include substantially identical steps except method 400b substitutes steps 404b and 406b for steps 404 and 406 of method 400. These substituted steps 404b and 406b are similar to the corresponding steps 404 and 406 expanded to utilize the additional transceivers 37 and 38 of FIG. 3B, for example.

After medical device data is received over a WLAN or PLAN network by transceivers 31 or 37 in step 402, the relay module 30a determines if any WWAN is accessible by transceivers 32 or 38 (e.g. in step 404b). If no WWAN is accessible the method 400b then continues to step 408 and performs substantially the same operations as described with respect to steps 408, 410 and 412 in FIG. 4A. Otherwise, if a WWAN is determined accessible in step 404b, the method 400b proceeds to step 406b. In step 406b, the method 400b transmits the medical data over the available WWAN via transceiver 32 or 38 to the appropriate access point.

Moreover, to the extent to that in step 404b there are more than one WWAN accessible, then in step 406b the controller 33 may determine which one of the accessible WWANs the medical data should be transmitted over by either of transceivers 32 or 38. Such determination can be made by many different criteria or rules including, for example, based upon signal strength, cost, time of day, day of week or preferences of a network manager or other user.

Referring now to FIG. 4C and FIG. 4D, As previously described with reference to the control panel 38 of the relay module configuration 370 of FIGS. 3E-3H, the relay module 30a is preferably provided with a relay module network indicator 380e to indicate a status of the portion of the WLAN or WPAN network 16 of FIGS. 1, 2 used to provide communications between the relay module 30a and its associated interface circuits 15 and medical devices 10. FIG. 4C presents a flow diagram illustrating a method of operation 420 for generating status information that may be used by network indicator 380e of FIG. 3H.

At steps 421, 422 of FIG. 4C, the processor 34 is instructed to retrieve a current module performance measure or history, for example, from the memory 35b for each medical device 15 accessible to the relay module 30a via the WLAN/WPAN network 16. Performance measures may, for example, include a measured signal strength, noise, bit rate, error rate, packet discard rate, occupancy, availability and the like as are conventionally measured for WLAN/WPAN networks. See, e.g., Pinto, WMM—Wireless Mesh Monitoring, Technical Report, INESC-ID, 2009, which is incorporated by reference in its entirety herein for all purposes. Measured performance may in addition take certain environmental information into account. For example, relatively elevated ambient operating temperature of the relay module 30a, and the like, which may lead to possible corruption of data from the medical device caused by such elevated ambient temperature.

At step 423, if the performance history is not sufficiently current (for example, as indicated by timestamp data) and/or missing, the processor 34 at step 424 employs conventional means in the transceiver 31 (for example, via status module 31b) to obtain current performance measures by transmitting a request to and receiving current performance data from the interface circuit 15 of the associated medical device 10, and preferably stores the current performance measures as part of the performance history in the memory 35b. Currency may preferably be determined according to system performance, regulatory and/or other requirements for individual performance measures in prescribed time intervals (for example, for an interval older than 5 seconds, older than 1 minute, older than the most recent each hour, or the like), which may be stored in the memory 35b for retrieval and reference by the processor 34.

After determining at steps 423 and 425 that current performance data has been obtained for each medical device accessible to the relay module 30a, the processor 34 at step 426 determines a current module status as a function of the current performance data and the performance history. For example, if the current performance data indicate that each medical device 10 is currently accessible to the relay module 30a, the module performance history indicates that the medical devices have been consistently accessible to the relay module 30a for a predetermined time (for example, over a period of several hours), and throughput and/or occupancy are within predetermined limits, the processor 34 may determine that the wireless relay network 16 is “healthy” (indicated, for example, at step 427 by illuminating a green LED segment of indicator 38e).

If the current performance data indicate that each medical device 10 is currently accessible to the relay module 30a, but one or more of the devices 10 have a recent performance history where one or more of throughput and/or occupancy were outside of the predetermined limits, the processor 34 may determine a status of “partially accessible” (indicated, for example, at step 427 by illuminating a yellow LED segment of indicator 38 e). If one or more of the medical devices 10 are presently inaccessible to the relay module 30a, the processor 34 may determine a status of “inaccessible” (indicated, for example, at step 427 by illuminating a red LED segment of indicator 380e). At step 428, it may be determined by the processor 34 for example in view of “partially accessible” or “inaccessible” statuses that an alarm condition has been generated, causing the processor 34 to present an alarm (for example, by causing the yellow or red LED segments to be illuminated in a blinking fashion, and/or by providing one or more audible alarms as previously described. As an alternative to displaying display status information at step 427, the processor 34 may cause the transceiver 31 to transmit the status information to one or more of the medical devices 10, or may cause the transceiver 32 to transmit the status information to a device in communication with the WWAN.

With further reference to FIG. 1A and FIGS. 3A-3I; FIG. 4D presents a flow diagram illustrating a method of operation 440 for generating the status information indicated by WWAN indicator 380j of FIG. 3H. At steps 441, 442 of FIG. 4D, the processor 34 retrieves a WWAN performance history, for example, from the memory 35b as to the status of the WWAN network 44. Performance measures may, for example, include a measured signal strength, noise, bit rate, error rate, call set up time, dropped call rate, occupancy and network availability and the like as are conventionally measured for WWAN/cellular networks for example, via the status module 32b. (See, e.g., Mike P. Wittie, et al., MIST: Cellular Data Network Measurement for Mobile Applications, Broadband Communications, Networks and Systems Fourth International Conference, IEEE, 2007, which is incorporated by reference in its entirety herein for all purposes). At step 443, if the performance history is not sufficiently current (for example, as indicated by timestamp data), the processor 34 at step 444 employs conventional means in the transceiver 32 to obtain current performance measures by transmitting a request to and receiving data from the access point 40 of FIG. 1A, and preferably stores the current performance measures as part of the performance history in the memory 35b. Alternatively, if the access point 40 and/or another device in communication with the WWAN 44 collects performance measurement data for the WWAN, the transceiver 32 may transmit a request to the access point 40 and/or other device to retrieve the performance data.

After determining at step 443 that the WWAN performance data is current, the processor 34 at step 445 determines a current WWAN status as a function of the current performance data and the performance history. For example, if the current performance data indicate that the WWAN 44 is currently accessible to the relay module 30a, the module performance history indicates that the WWAN 44 has been accessible to the relay module 30a for a predetermined time (for example, several hours), and throughput and/or occupancy are within predetermined limits, the processor 34 may determine that the WWAN 44 is “healthy” (indicated, for example, at step 446 by illuminating a green LED segment of the WWAN indicator 38j).

If the current performance data indicate that the WWAN 44 is currently accessible to the relay module 30a, but has a history where one or more of throughput and/or occupancy was outside of the predetermined limits, the processor 34 may determine a status of “partially accessible” (indicated, for example, at step 446 by illuminating a yellow LED segment of the WWAN indicator 38j).

If the WWAN 44 is presently inaccessible to the relay module 30a, the processor 34 may determine a status of “inaccessible” (indicated, for example, at step 446 by illuminating a red LED segment of the WWAN indicator 38j). At step 447, which may be performed before or concurrently with step 446, it may be determined by the processor 34 for example in view of “partially accessible” or “inaccessible” statuses that an alarm condition has been generated, causing the processor 34 to present an alarm (for example, by causing the yellow or red LED segments to be illuminated in a blinking fashion, and/or by providing one or more audible alarms as previously described. As an alternative or in addition to displaying display status information at step 446, the processor 34 may cause the transceiver 31 to transmit the status information to one or more of the medical devices 10, or may cause the transceiver 32 to transmit the status information to a device in communication with the WWAN.

FIG. 4E presents a flow diagram illustrating a method of operation 460 for generating the status information that may be used by WLAN/WPAN indicator 380i of FIG. 3H to indicate an overall health of the entire WLAN/WPAN (or at least of the portion available to provide an alternate path for the relay module 30a to the WWAN network). At steps 461, 462 and 464 of FIG. 4E, the processor 34 retrieves current module performance history from the memory 35b for communications with each other relay module that is accessible to the relay module 30a via the WLAN/WPAN network 16 (“neighbor module”).

As previously described, performance measures may, for example, include a measured signal strength, noise, bit rate, error rate, occupancy, availability, path usage and the like as are conventionally measured for WLAN/WPAN networks (using, for example, the status module 31b). In addition, at step 463, the processor operates the transceiver 31 to request that each neighbor module provide a WWAN status (prepared, for example, according to the method described with reference to FIG. 4D).

At step 465, if the performance history relative to the neighbor modules is not sufficiently current (for example, as indicated by timestamp data) and/or missing, the processor 34 at step 466 employs conventional means in the transceiver 31 to obtain current performance measures by transmitting data to and receiving data from the neighbor modules, and preferably stores the current performance measures as part of the performance history in the memory 35b. In addition, current performance measures may be obtained with respect to other neighboring devices, for example, having known or discernible performance (for example, network “beacons”).

After determining at step 467 that current performance data has been obtained for each neighbor module accessible to the rely module 30a, the processor 34 at step 468 determines a current module status as a function of the current neighbor module performance data (including neighbor module WWAN status) and the neighbor module performance history. For example, if the current performance data indicate that each neighbor module 30a is currently accessible to the relay module 30a and has a WWAN status of “accessible”, the module performance history indicates that the neighbor modules 30a have been accessible to the relay module 30a for a predetermined period of time, and throughput and/or occupancy are within predetermined limits, the processor 34 may determine a status of “fully accessible” (indicated, for example, at step 469 by illuminating a green LED segment of WLAN/WPAN indicator 380i).

If the current performance data indicate that each neighbor module 30a is currently accessible to the relay module 30a, but one or more of the neighbor modules 20a have a recent performance history where WWAN status was inaccessible, the processor 34 may determine a status of “partially accessible” (indicated, for example, at step 469 by illuminating a yellow LED segment of WLAN/WPAN indicator 380i). If at least two of the neighbor modules 30a are not presently accessible to the relay module 30a, the processor 34 may determine a status of “inaccessible” (indicated, for example, at step 469 by illuminating a red LED segment of WLAN/WPAN indicator 38i). At step 470, it may be determined by the processor 34 for example in view of “partially accessible” or “inaccessible” statuses that an alarm condition has been generated, causing the processor 34 to present an alarm (for example, by causing the yellow or red LED segments to be illuminated in a blinking fashion, and/or by providing one or more audible alarms as previously described. As an alternative to displaying display status information at step 469, the processor 34 may cause the transceiver 31 to transmit the status information to one or more of the medical devices 10, or may cause the transceiver 32 to transmit the status information to a device in communication with the WWAN.

FIG. 4F presents a flow diagram 413 illustrating a method of operation for emergency dialing. In accordance with the flow diagram 413, the processor 34 of the relay module 30a of FIG. 3 determines whether to transmit over the facility-oriented wireless network or the WWAN and makes a determination based on the medical device data whether an emergency condition exists as represented by step 414. If such a condition exists then, in step 415, the processor 34 transmits a message to the phone device 39a to activate it and also initiate a connection in step 416 (e.g., phone call, etc.) with an emergency responder, such as 911, relatives/friends, caregivers, or police authorities. When the call is received by the emergency responder, an automated voice message is preferably transmitted to the emergency responder by the signal generator 39b indicating the emergency condition and location of the condition. If an emergency condition does not exist in step 414, in step 417 then the medical device data is stored for further analysis by the monitoring unit 37b.

FIG. 4G presents a flow diagram 418 illustrating how a location signal may be generated. A determination is made in step 474 by the processor 34 as to whether GPS location data was received as a component of the medical device data received from a medical device. If yes, in step 476, the processor 34 provides the location data for transmission with emergency condition data to the emergency responder. If that location data is not available, at step 478 a location device 38 of the relay module 30a is instructed by the processor 34 to generate location data of the relay module 30a. At step 480, the processor 34 provides the location data for transmission with emergency condition data to the emergency responder as a component of the message transmitted by the phone device 39a.

FIG. 4H presents a table as may be stored for example in memory 35b by the relay module 30a for determining whether an emergency condition exists. As illustrated, the table 481 includes codes 482 to indicate predetermined emergency conditions, descriptions 486 for the emergency conditions, harm times 488 defining an elapsed time until the emergency condition becomes harmful, priorities 490 for triage purposes, related codes 492 to the coded emergency condition, and physiological data 494 used to identify the emergency condition. For example, as shown in line 1 of the table of FIG. 4H, a code value 482 of “2” is assigned to the description 486 “Significant fever condition,” which is assigned an unattended harm time 488 of “10 minutes” and an immediate priority of 490 of “5.” A related condition 492 indicates that this condition in related to a code value 482 of “7,” which corresponds to the description 486 “Vital signs decreasing.” The code value 2 in addition corresponds to physiological conditions 494 (“Temp . . . gtoreq. 103”).

FIG. 5 presents a flow diagram illustrating a method of operation 500 for the architecture according to FIG. 1A, relating to the transmission of a message from the access point 40 to be received by one of the medical devices 10. This enables the access point 40, for example, to communicate with medical devices in order to download new firmware or software, to respond to error messages initiated by the medical devices (for example, to re-set a device or remove it from service, or to run device diagnostics), and to operate the medical device (for example, to adjust a flow rate on a feeding pump).

At step 502 of the method 500, the message is received at the first one of the relay modules 30a from the access point 40 via the WWAN. At step 504, the one relay module 30 determines whether the message is intended to reach one of the interface circuits 15 and/or other relay modules 30, 30a located in the facility 20. This may be accomplished, for example, by maintaining a list of active devices 15 and modules 30, 30a in the buffer 35 or in a manner otherwise accessible to the one relay module 30a, or coding an identifier of the device 15 or module 30, 30a to include an identity of the facility 20 that is stored in the buffer 35 or is otherwise identifiable to the one relay module 30 or 30a. In the alternative, the received message may include a device identifier such as a serial number or an assigned identifier. Such a received message would then be broadcasted to all or a subset of interface circuits 15 in the facility and each interface circuit 15 determines if it was the intended recipient and should act upon or ignore the message.

If the one relay module 30a determines at step 506 that the interface circuit 15 or module 30, 30a is not located in the facility, the one relay module 30a may preferably proceed to discard the message at step 508, and/or alternatively alert the access point 40 with a non-delivery message. If the interface circuit 15 is located in the facility 20, the one relay module 30a determines at step 510 whether the interface circuit 15 or relay module 30, 30a accessible to the one relay module 30a via the WLAN or WPAN (for example, by consulting a list stored in the buffer 35 or that is otherwise accessible to the one relay module 30a, or by instructing the transceiver 31 to send a handshake or test transmission directed to the interface circuit 15 and to listen for a reply).

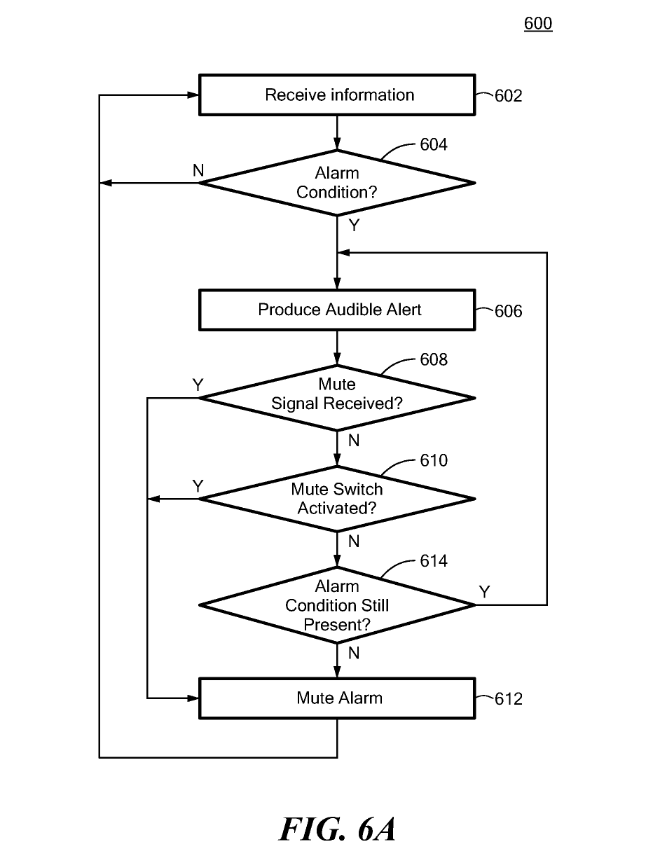

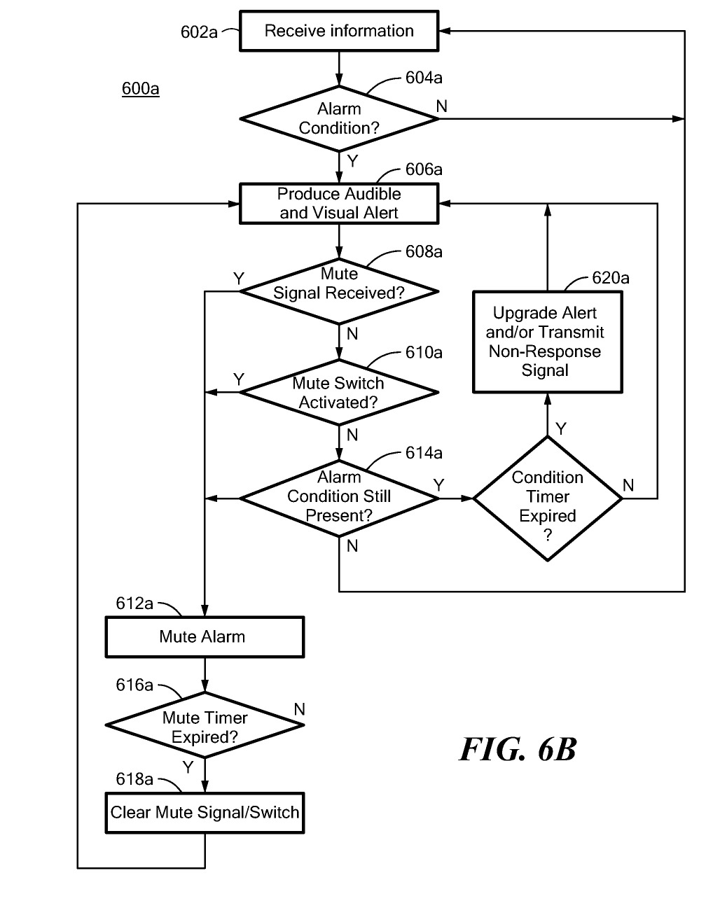

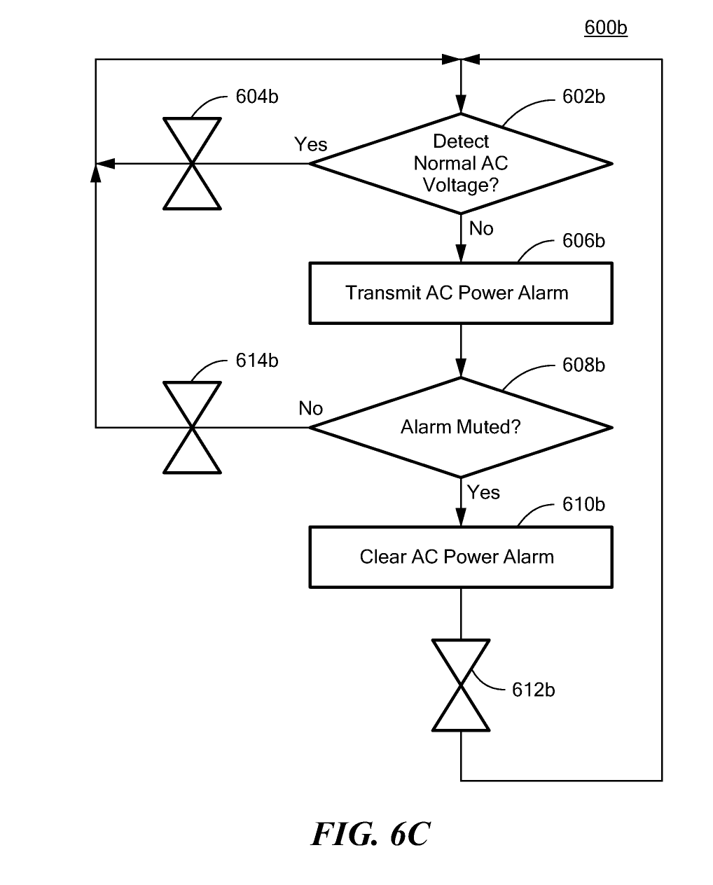

If the one relay module 30a determines at step 512 that the device 15 or relay module 30, 30a is accessible, then at step 514, it transmits the message via network 16 to that device or relay module via the transceiver 31, or to relay module 30, 30a via the transceiver 31. In this case, the message may again be broadcasted to all devices 15 and modules 30, 30a in communication with the one relay module 30a, and each device 15 or module 30, 30a may decide to act on or ignore the message (for example, by matching to an associated device ID or other identifier in the message). If the one relay module 30a alternatively determines at step 512 that the device or relay module is not accessible, then it proceeds at step 516 to determine whether a second relay module 30, 30a is accessible via the WLAN or WPAN (for example, by instructing the transceiver 31 to send a handshake transmission directed to the second relay module and to listen for a reply). If the second relay module 30, 30a is available, then the one relay module 30 forwards the message to the transceiver 31 for transmission to the second relay module 30, 30a over the WLAN or WPAN. If the second relay module 30, 30a is inaccessible, then this portion of the process 500 may preferably be repeated to search for a third relay module 30, 30a that is accessible. Alternatively, or in the event that no other relay module 30, 30a is available, the one relay module 30 may preferably issue an alarm notification at step 522, preferably in one of the same manners described above in reference to the methods described in conjunction with FIGS. 6A-6D below. The processor 34 may also issue alarm notifications upon failing to receive a handshake signal from other medical devices 10 and/or relay modules 30, 30a.

FIG. 6A depicts a flow diagram 600 representing an alarm alert and display process. In accordance with the flow diagram 600, at step 602 the processor 34 of the relay module 30a receives information such as medical device data from a medical device, other rely module or internally generated by the relay module. Then, the method 600, in step 604, determines whether the information obtained in step 602 is indicative of an alarm condition or an alarm condition is otherwise present. If no alarm condition is detected at step 604, then method 600 reverts back to step 602. If, in step 604, an alarm condition is detected based on the obtained information by step 602, the method 600 proceeds to step 606.

In step 606, the processor 34 produces an alarm alert by transmitting signals representing an alert to be displayed to the display 36 and/or transmits signals representing speech or other audible information (for an audible alarm) to the speaker. Then, the method 600 proceeds to step 608. In step 608, it is determined whether the module 30a receives medical device data or other information instructing the module to mute or disable the audible alarm or an input signal is otherwise received requesting to mute the sound or disable the audible alarm. If such input signal is received then, in step 612, the processor 34 mutes the speaker, i.e., disable the audible alarm. However, in step 608, if no such input signal is received then the method 600 proceeds to step 610.

In step 610, the processor 34 determines whether a user-actuatable switch associated with the input/output circuit 38, e.g., a mute switch of the relay module 30a, has been activated. If such a switch has been activated then the method 600 proceeds to step 612 and the speaker is muted to disable the emitted audible alarm. After the speaker is muted, the method 600 returns to step 602 and starts the process again. However, if in step 610, it is determined that the mute switch has not been activated then the method 600 proceeds to step 614 where the processor again determines whether the alarm condition is still present based upon, for example, newly received medical device data. If the alarm condition is no longer present, the method 600 proceeds to step 612 and the audible alarm is disabled. However, if in step 614 the alarm condition is still present then the method 600 reverts back to step 602 and the audible alert is produced, i.e., continued.

In an alternative embodiment, if in step 614 the alarm condition is present for a particular period of time (either fixed in duration or based upon the particular alarm condition), then in step 606 the emitted audible alarm may advantageously be changed or upgraded in decibel level, pitch, type of sound, duty cycle or speech command to draw greater attention and response to the alarm condition by potential responders. In addition to, or in the alternative to, this change in emitted audible alarm in response to the determination in step 614 that the alarm condition is present for a particular period of time then the relay module may transmit a signal to other nearby or remote relay module(s) to alert other potential responders of the alarm condition. It should be understood that the method of 600 may operate with information received from plurality of medical devices or other wireless relay modules, and may provide the intermittent displaying of respective alarm alerts for particular time intervals or employ different foreground or background colors based upon the type or severity of the alarm condition.

FIG. 6B depicts a flow diagram representing a alarm alert and display process 600a. Some of the steps in process 600a may be the same as or similar to steps in process 600.

In accordance with the flow diagram 600a, at step 602a the processor 34 of the relay module 30a of FIG. 3 receives information such as medical device data from a medical device, another relay module or internally generated by the relay module. Then, the method 600a, in step 604a, determines whether the information obtained in step 602a is indicative of an alarm condition or an alarm condition is otherwise present. If no alarm condition is detected at step 604a, then method 600a reverts back to step 602a. If, in step 604a, an alarm condition is detected based on the obtained information by step 602a, the method 600a proceeds to step 606a.

In step 606a, the processor 34 produces an audible and visual alarm alert by transmitting signals representing an alert to be displayed to the display 36 and/or transmits signals representing speech or other audible information (for an audible alarm) to the speaker. Alternatively and/or in addition, the processor 34 may transmit the alarm alert to a medical device 10 via the transceiver 31, and/or to the access point 40 via the transceiver 32. Then, the method 600a proceeds to step 608a.

In step 608a, it is determined whether the module 30a receives medical device data or other information instructing the module to mute or disable the audible alarm or an input signal is otherwise received requesting to mute the sound or disable the audible alarm. If such input signal is received then, in step 612a, the processor 34 mutes the speaker to disable the audible alarm. However, in step 608a, if no such input signal is received then the method 600a proceeds to step 610a.

In step 610a, the processor 34 determines whether a user-actuatable switch associated with the input/output circuit 38, e.g., a mute switch of the relay module 30a, has been activated. If such a switch has been activated then the method 600a proceeds to step 612a and the speaker is muted to disable the emitted audible alarm. The method 600a then proceeds at step 616a to determine whether a mute timer has expired after a predetermined time interval (for example, 5 minutes). If so the mute signal is cleared and/or the mute switch is released at step 618a, and the method 600a returns to step 606a to produce each of the audible and visual alerts.

If in step 610a, it is determined that the mute switch has not been activated, then the method 600a proceeds to step 614a where the processor again determines whether the alarm condition is still present based upon, for example, newly received medical device data. If the alarm condition is no longer present, the method 600a proceeds to step 602a and the alarm is disabled. However, if in step 614a the alarm condition is still present, the method proceeds at step 423 to check a condition timer to determine whether the alarm condition has been present for a particular period of time (either fixed in duration for example of five minutes, or for a variable duration based upon the particular alarm condition). If the condition timer has expired in step 423, then in step 620a the emitted audible alarm may advantageously be changed or upgraded in decibel level, pitch, type of sound, duty cycle or speech command to draw greater attention and response to the alarm condition by potential responders, and reapplied at step 606a. In addition to, or in the alternative, the relay module 30, 30a at step 620a may transmit a signal to other nearby or remote relay module(s) to alert other potential responders of the alarm condition.

It should be understood that the method of flow diagram 600a may operate with information received from a plurality of medical devices or other wireless relay modules, and may provide the intermittent displaying of respective alarm alerts for particular time intervals or employ different foreground or background colors based upon the type or severity of the alarm condition.

FIG. 6C depicts a flow diagram 600b representing an alarm monitoring process executed by the processor 34 and the power monitoring device 39b with respect to the AC power supply to the relay module 30a. At step 602b, the processor 34 interrogates the power monitoring device 39b to determine whether the external AC power supply is providing a “normal” voltage (for example, 120 VAC, 60 Hz). If the external AC power supply is providing a normal voltage, the processor engages a timer 604b to operate for a predetermined period of time (for example, 2 minutes) and then returns to step 602b. If the external AC power supply is not providing a normal voltage (for example, a voltage less than 105 VAC, including 0 VAC resulting from an external AC power disconnect), the processor 34 causes a power alarm message to be transmitted at step 606b. At step 608b, the processor determines whether an audible portion of the alarm resulting from the transmitted alarm message has been muted (for example, by activating the mute switch of the relay module 30a). If yes, the processor 34 transmits a message to clear the alarm at step 610b, engages a timer to operate for a second predetermined period (for example, 5 minutes), and then returns to step 602b. If not, the processor 34 engages a timer 614b to operate for another predetermined time period (for example, 3 minutes), and then returns to step 602b. Alternatively, at step 608b, the processor 34 may clear the muted condition rather than clearing the alarm, and release the alarm only if a normal voltage is detected as step 602b.

FIG. 6C depicts a flow diagram 600c representing an alarm monitoring process executed by the processor 34 and the power monitoring device 39b with respect to the secondary power source 39c to the relay module 30a. At step 642c, the processor 34 interrogates the power monitoring device 39b to determine whether the secondary power source 39c is providing a “normal” voltage (for example, 9 VDC). If the secondary power source 39c is providing a normal voltage, the processor engages a timer 644c to operate for a predetermined period of time (for example, 1 minute) and then returns to step 642c.

If the secondary power source 39c is not providing a normal voltage (for example, a voltage less than 8.5 VDC), the processor 34 interrogates the power monitoring device 39b to at step 646c to determine whether the secondary power source 39c is providing a “low” voltage (for example, between 7 and 8.5 VDC). If yes, the processor causes a low battery alarm message to be transmitted at step 648c. At step 650c, the processor determines whether an audible portion of the alarm resulting from the transmitted alarm message has been muted (for example, by activating the mute switch of the relay module 30a). If yes, the processor 34 transmits a message to clear the alarm at step 652c, and engages a timer 654c to operate for a predetermined period (for example, 1 minute) and returns to step 642c. If not, the processor 34 engages another timer 656c to operate for another predetermined time period (for example, 2 minutes) and then returns to step 642c.

If the processor 34 at step 646c determines that the secondary power source 39c is not providing a “low” voltage (for example, between 7 and 8.5 VDC), the processor 34 concludes at step 658c that the voltage is a “near death” voltage (for example, less than 7 VDC). The processor 34 then begins at step 660c to store medical device data arriving from one or more medical devices 10 via the wireless relay network and/or from the access point 40 via the internet-accessible wireless communications network in the memory 35b, and causes a near death battery alarm message to be transmitted at step 662c. At step 664c, the processor determines whether an audible portion of an alarm resulting from the transmitted alarm message has been muted (for example, by activating the mute switch of the relay module 30a). If yes, the processor 34 transmits a message to clear the alarm at step 666c, and engages a timer 668c to operate for a predetermined period (for example, 1 minute) and returns to step 642c. If not, the processor 34 engages another timer 670c to operate for another predetermined time period (for example, 2 minutes) and then returns to step 642c. If normal battery voltage is detected at step 642c, the processor 34 retrieves any medical device data that was stored in the memory 35b during the period when a “near death” voltage was detected, and transmits the retrieved medical device data to intended destinations via one or more of the wireless relay network and/or the internet-accessible wireless communications network.

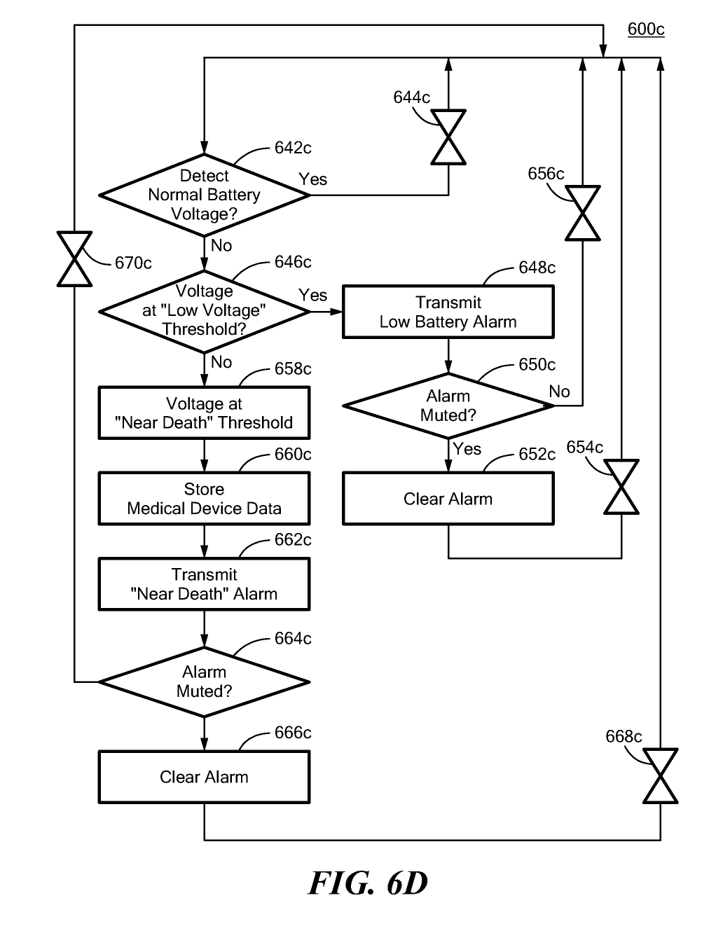

FIG. 7 depicts a flow diagram 800 representing a process executed by the wireless relay module to determine whether communications with a particular medical device 10 can be carried out over the wireless relay network 16. The process begins with the processor 34 of the wireless relay module 30a engaging a timer 802 for a predetermined period of time (for example, 5 minutes). After expiration of the timer 802, the processor 34 instructs the transceiver 31 to transmit a “heartbeat” request to the medical device 10 over the wireless relay network. If a response is received by the transceiver 31 to the request, the process concludes at step 808 and the processor once again engages the timer 802.

If no response to the request is received by the transceiver 31, the processor 34 increments a request counter at step 810 and engages another timer 812 for another predetermined period of time (for example, 1 minute). Then, the processor 34 proceeds to resend the heartbeat request at step 814. If a response is received by the transceiver 31 to the resent request, the process concludes at step 808 and the processor again engages the timer 802. If no appropriate response is received, the processor 34 proceeds at step 818 to determine whether the request counter exceeds a predetermined value (for example, a predetermined value of 5). If this value is exceeded, the processor 34 causes at step 820, a heartbeat alarm to be displayed by the display 36 and/or be audibly signaled by the speaker 37, and/or transmits a message via at least one of the transceivers 31, 32 to the access point 40 and/or to another internet-accessible and/or wireless network-accessible recipient. The process then continues at step 808 and the processor once again engages the timer 802. If the predetermined value of the request counter is not exceeded at step 818, the process returns to step 810.

One of ordinary skill in the art will readily understand that, in addition to requesting a “heartbeat” from the medical device 10, a variety of other measures may be obtained to determine whether communications with a particular medical device 10 can be carried out over the wireless relay network 16. For example, the processor 34 of the wireless relay module 30a may alternatively instruct the status module 31b associated with the transceiver 31 to determine one of a variety of measures of signal quality for the wireless relay network signals being received from a medical device 10 (for example, including a signal strength or data rate of the transmitted signal).

The architecture disclosed herein for providing networked communications between a series of medical devices and a remote monitoring device provides a number of distinct advantages in comparison to other monitoring systems. By employing wireless relay networks such as ZIGBEE networks based on the IEEE 802.15.4 standard, for wireless communications between the medical devices 10 and relay modules 30, 30a in accordance with one embodiment, power and size requirements can be minimized so that the interface circuits 15 can be easily and inexpensively applied to and/or integrated with the medical devices 10.

By introducing relay modules 30a that are part of the wireless relay mesh networks with the capacity to access off-site monitoring devices via a WWAN, access to and reliance on existing and potentially unreliable LAN facilities at a facility can be avoided. By incorporating relay features into the relay modules 30a that relay communications from a first relay module 30a through a second relay module 30a in the event that WWAN access to the first relay module 30a has been compromised, reliability can be improved and the use of conventional, low-cost cellular transceivers can be enabled in the relay modules 30a for accessing the WWAN.

By limiting the configuration of cellular transceivers to just the relay modules 30a, costs can be further reduced. In addition, providing the relay modules 30a in a compact enclosure facilitates the relay modules 30a to be easily connected to reliable commercial power sources and easily moved when needed to reconfigure the wireless relay networks (e.g. a to a mesh network) according to facilities changes. The portability for ambulatory use that is provided by battery back-up is an additional advantage.

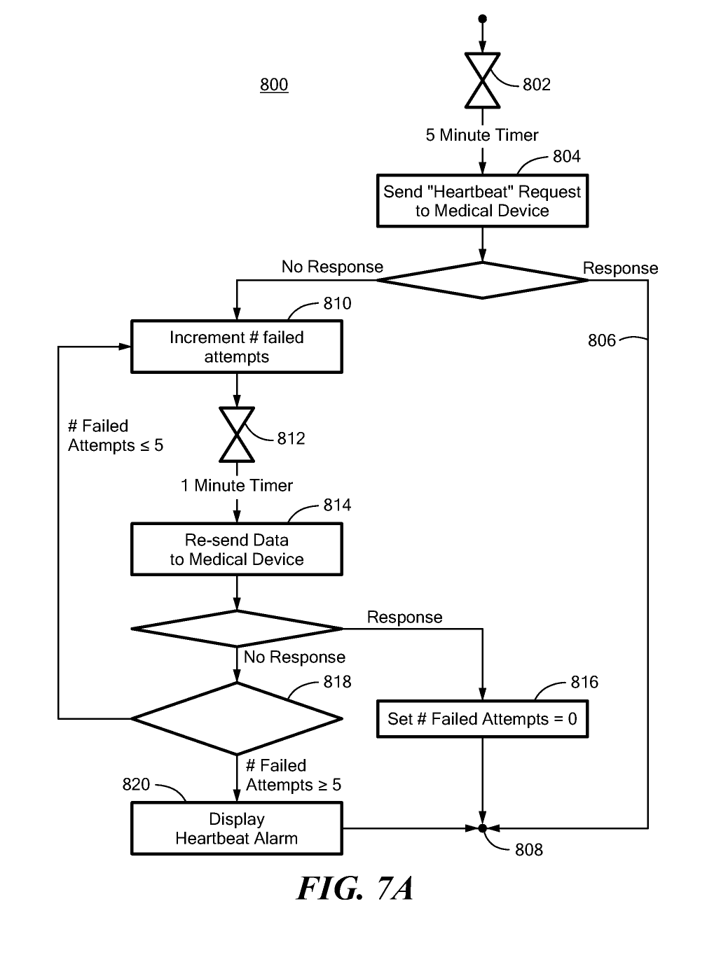

Referring now to FIG. 8, a network 16a includes a plurality of nodes with at least one or more of the nodes corresponding a relay node 30, 30a and at least one or more of the nodes corresponding to a medical device 200a-200h. In the illustrative embodiment of FIG. 8, each of the plurality of relay nodes 30, 30a and each of the plurality of medical devices 200a-200h are included in network 16a. At least some of the medical devices 200a-200h are capable of wirelessly communicating at least some medical data to at least some of the plurality of relay nodes 30, 30a. Thus, Illustrative network 16a is provided as a wireless relay network having a so-called mesh network topology.

In some embodiments, each of the plurality of medical devices 200a-200h are in communication with each other as well as in communication with each of the plurality of relay nodes and each of the plurality of relay nodes 30, 30a are in communication with each other as well as in communication with each of the plurality of medical devices 200a-200h. Thus, in this case, network 16a may be referred to as a fully connected mesh network.

It should be appreciated that the elements shown in FIG. 8 may be the same as or similar to the elements shown In FIG. 2A. Furthermore, any of the processes and methods described above may operate in conjunction with network 16a of FIG. 8 and the relay modules and medical devices associated with network 16a.

In an embodiment, the medical devices 200a-200h may perform some or all of the same functions or processes as relay modules 30, 30a described herein. Furthermore, medical devices 200a-200h may include some and/or all components and elements of relay modules 30, 30a as described above.

In an embodiment, a number of medical devices 200a-200h and relay modules 30, 30a are arranged in a relay network 16a within the patient facility 20. As described above, medical devices 200a-h may include or be in communication with interface circuits 15 for wirelessly communicating with at least some of the other nodes e.g. 30, 30a, 200a-200h) comprising the wireless relay network 16a. It should be understood that medical devices 200a-h and relay modules 30, 30a may communicate over other wireless relay networks similar to network 16a in the patient facility 20.

Medical devices 200a-200h may be any instrument, apparatus, implant, in vitro reagent, or similar or related article that is used to diagnose, prevent, and/or treat disease or other conditions. Medical devices 200a-200h need not all be the same type of device and in fact may vary greatly in complexity and application. Examples range from relatively simple devices such as tongue depressors, medical thermometers, and disposable gloves to relatively advanced devices such as computer or other processor based devices which assist in the conduct of medical testing, implants, and prostheses.

Medical devices 200a-h may be either portable or stationary devices. In network 16a, for example, some medical devices 200a-h may be portable while others may be stationary devices.

Medical devices may be used in a medical environment, such as a hospital or in any other health care facility including, but not limited to, home health care environments.

A medical device is thus any instrument, apparatus, implant, in vitro reagent, or similar or related article that is used to diagnose, prevent, or treat disease or other conditions. Accordingly, medical devices 200a-h include, but are not limited to, machines for taking tests and measurements from a patient (an electrocardiogram machine, for example), for administering drugs to a patient (an electronically flow control for an IV, for example), for performing a procedure on a patient (an automatic external defibrillator or automatic chest compression machine, for example), etc.

Medical devices may vary greatly in complexity and application. Examples range from relatively simple devices such as tongue depressors, medical thermometers, and disposable gloves to relatively complex devices such as computers or other processing devices (e.g. mobile devices such as tablets) which assist in the performance conduct of medical testing, implants, and prostheses.

In one embodiment, each of the medical devices 200a-h included in network 16a are the same type of device. In other embodiments, some or all of the medical devices 200a-h may be provided as different types of medical devices, some or all of which, can communicate over the wireless relay network.

In FIG. 8, the medical devices 200a-h and relay modules 30, 30a are configured to communicate with one another via associated network signal paths (also sometimes referred to herein as “communication paths,” “communication channels” or “links”) such as signal paths 202 and 204, for example. It should be appreciated that in preferred embodiments the signal paths in network 16a are bi-directional (i.e. data can be transferred in either direction between nodes coupled to the signal path). In other embodiments, however, some or all of the signal paths may be unidirectional (i.e. data can be transferred in only one direction between nodes coupled to the signal path). In still other embodiments, some of the signal paths may be bi-directional while others of the signal paths may be unidirectional (i.e. network 16a may include a combination of bi-directional and unidirectional signal paths).

For example, in one illustrative embodiment, medical device 200a can communicate with the relay modules 30 (also denoted 203) via bi-directional network link 202. Similarly, medical device 200a can communicate with medical device 200b via bi-directional network link 204. One of ordinary skill in the art will recognize that it is possible for medical devices 200a-h and relay modules 30, 30a to communicate with the other devices connected to the wireless relay network 16a even if a communication link is not shown (i.e. if desired, the network 16a can be provided as a fully connected mesh network).

As noted above, the connections between devices within network 16a may be mesh network connections. For example, if network 16a operates in accordance with a ZigBee communication protocol (in which case network 16a may sometimes be referred to as ZigBee network, then the connections between medical devices 200a-h, relay devices 30, and relay devices 30a may be mesh network connections. It should, of course, be appreciated that other types of communication protocols may also be used to provide network 16a as a mesh network.

It should be appreciated that signal paths 220, 222, and 224 between relay devices 30a and access point 40, may operate in accordance with other communication protocols such as a Wi-Fi connection, a GSM connection, a cellular network connection, an Ethernet (or other wired network) connection, etc. As noted above, relay devices 30a may have one transceiver for communicating on the network 16a (e.g. a mesh network), and another transceiver for communicating with external networks, such as a network for communicating with access point 40. In other embodiments, connections 220, 222, and 224 can also be mesh network connections. In this way, relay modules 30a can connect to other resources (e.g. other network resource not shown in FIG. 8) such as the Internet via the wireless network access point 40. It should be appreciated that since medical devices 200a-200h may also communicate with relay nodes 30a (either directly or indirectly such as through one or a plurality of other medical devices 200a-200h or through one or a plurality of rely modules 30) and thus medical devices 200a-200h may connect to other resources (e.g. other network resource not shown in FIG. 8) such as the Internet via the wireless network access point 40.

When network 16a is provided as a mesh network, communication channels between network nodes (i.e. relay modules 30, 30a, and/or medical devices 200a-200h) may be established or interrupted (i.e. “broken”) under certain circumstances. For example, if medical device 200a is moved to a location distant from medical device 200b, or to a location where there is interference with wireless communications, communications between the two nodes 200a, 200b may degrade to a point where reliable communications between the two nodes 200a, 200b is not possible or communication link 204 may break. Once the interference is removed and/or the medical devices are moved closer to each other, communication link 204 may be re-established.

In an embodiment, the communication channels over which information signals (or more simply “information”) may be transmitted between the nodes 30, 30a, 200a-200h which make up the network 16a (e.g. the one or more medical devices and one or more relay modules which form the network) are provided from a physical transmission medium (e.g. a wire, RF cables or optical fiber, for example) and in this case, network 16a may be referred to as a wired network. In other embodiments, the network 16a is a wireless network. In still other embodiments the network 16a may include a combination of wired and wireless connections between devices and relay modules. In cases where network 16a is a wireless network (e.g. a network in which information is transmitted between the nodes without the use of a physical transmission medium), relay modules are provided as wireless relay modules and the signal paths between the nodes are broadcast (e.g. RF, microwave, satellite, infrared, for example) communication channels including communication links).

In one embodiment, the network 16a operates in accordance with a mesh network protocol (in which case network 16a may be referred to as a mesh network) such as a ZIGBEE mesh network protocol based on IEEE 802.15.4. Those of ordinary skill in the art will appreciate of course, that network 16a may operate in a accordance with a wide variety of different network protocols including, but not limited to a WIRELESSHART mesh network protocol (a time synchronized, self-organizing, and self-healing protocol for use in a network having a mesh architecture) and/or a MIWI network protocol. However, it should also be appreciated that the wireless relay network 16 or additional wireless relay networks in the patient facility may be organized according to a variety of other wireless local area network (WLAN) or WPAN formats including, for example, WiFi WLANs based on IEEE 802.11 and BLUETOOTH WPAN s based on IEEE 802.15.1.

In an embodiment, the interface circuits 15 are integral to a respective medical device 200a-h. In another embodiment, the interface circuits 15 are separate from but in communication with a respective medical device 200a-h. In such an embodiment, the interface circuits 15 may include a communications interface such as, for example, a wired or wireless network interface, to an associated medical device 200a-h. In addition, each of the interface circuits 15 may include a wireless communication interface for communicating on network 16a, to allow the associated medical device to communicate with relay modules 30, 30a and to communicate with other medical devices 200a-h.

The relay modules 30, 30a include at least one transceiver configured to communicate with other relay modules 30, 30a in the wireless relay network 16a. Relay modules 30a further include at least a second transceiver for communicating over the WAN with the access point 40.

Additionally or alternatively, one or more of the medical devices 200a-h can include a transceiver configured for communicating over the WAN with wireless access point 40, as shown by network link 206 between medical device 200a and WAN access point 40.

Wireless access point 40 may be configured to communicate with and provide access to a WAN network such as, for example, networks based on a Global System for Mobile Communications (GSM) or Code Division Multiple Access (CDMA) cellular network or associated with the 2G, 3G, 3G Long Term Evolution, 4G, WiMAX cellular wireless standards of the International Telecommunication Union-Radiocommunication Sector (ITU-R). For compliance with Health Insurance Portability and Accountability Act of 1996 (HIPAA) regulations, communications over each of the facility oriented wireless network and WWAN may be conducted securely using, for example, using a Secure Sockets Layer (SSL) protocol or a Transport Layer Security (TLS) protocol.

The use of a mesh network for network 16 provides the advantages of being self-configurable when one or more medical devices 200a-h and/or relay modules 30, 30a are added to the network, and self-healing when one or more medical devices 200a-h and/or relay modules 30, 30a are removed from or otherwise disabled in the network. Subgroupings of the interface circuits 15 and relay modules 30, 30a may be provided in a defined geographic space (for example, on an individual floor or within a region of a floor in a multifloor home or care facility).

In one embodiment, medical devices 200a-h are configured to communicate directly or indirectly with other medical devices on network 16, with one or more relay modules 30, 30a, and/or WAN access point 40. As shown in FIG. 8, medical device 200a is in communication with medical device 200b, one or more of the wireless relays 30, and WAN access point 40. Medical devices 200b-200e are in communication with other medical devices and with one or more of the wireless relays 30. And medical device 200f is shown as being in communication only with medical device 200e. Medical device 200g is shown as being in communication only with a wireless relay 30 while medical device 200h is shown as in communication with two wireless relay modules 30. One skilled in the art will recognize that the network in FIG. 8 is shown as an example only and that other connection topologies are possible.

In some embodiments, one or more of medical devices 200a-200h may act as a communication relay module within the network 16a. For example, medical device 200h may receive communications from a relay module 30 via communication link 208 and send or relay communications to a relay module 30a via communication link 210. Similarly, medical device 200b may receive communications from medical device 200a via communication link 204 and send or relay communications to a relay module 30 via communication link 212. Medical device 200b may also receive communications from a relay module 30 via communication channel 212 and send or relay communications to medical device 200a via communication channel 204. Accordingly, the medical devices 200 may include any of the components and/or functionality described above with respect to the relay modules 30, 30a, including, but not limited to, sending alerts, determining network accessibility, routing communications, etc.

Medical devices 200a-200h can send and receive communications and data over the network 16. The data can include data and information to be received by the medical device, such as commands received by the medical device that initiate an action by the medical device. For example, the medical device may receive a command to perform a test, to perform a procedure, to administer a drug, to send stored data, to send patient information or information about the medical device, etc. In an embodiment, these commands may be initiated by a user at a remote console, by another device on the network that is programmed to send such command, or the like.

The data can also include data and information generated by the medical device and sent to other devices on network 16. For example, a medical device can generate medical test data, data identifying the patient or the medical device, alarms, and other types of data that can be sent to the network 16.

The data sent and received by the medical devices can be relayed to the medical device through relay modules 30, 30a, and/or through other medical devices.

For example, as shown in FIG. 8, a first communication path 202 exists between medical device 200a and relay module 30. A second communication path 204 exists between medical device 200a and medical device 200b and a third communication path 206 exists between medical device 200a and WAN access point 40. Thus, in this illustrative embodiment, medical device 200a is capable of communication with a plurality of different devices (e.g. medical device 200b, relay module 30, and WAN access point 40) and consequently, medical device 200a may send and receive data to and from medical device 200b, the relay module 30, and WAN access point 40.

Having multiple communication paths 202, 204, 206 coupled to medical device 200a helps ensure that, at substantially any point in time, medical device 200a has the ability to transmit information to a location which is remote from the patient facility (such as to one or more of remote monitoring devices 61, 62 and 63) over a broad-band network (such as broad-band network 50) as described above and illustrated in FIG. 1A, for example. One or more of remote monitoring devices 61, 62 and 63 may correspond to an emergency medical records (EMR) system, for example.

In one example, medical device 200g generates medical information to be provided to a remote monitoring devices (e.g. one or more of 61, 62 and 63 of FIG. 1A, for example,) over a broad-band network (such as broad-band network 50 of FIG. 1A, for example). In general overview, medical device 200g transmits the information to access point 40 over a communication channel A made up from communication channel portions A1-A9. It should of course be appreciated that portion A9 of communication channel A is achieved over a 3G or 4G channel and thus portion A9 of communication channel A is not properly a part of relay network 16a.

Medical device 200g generates medical information and then transmits the medical information to a relay module 30 over a communication channel A1. Since in this example, the medical information originates at medical device 200g, medical device 200g is sometimes referred to as the “originating medical device” or: “source medical device” (or more simply as the “originating device” or “source device.” Relay module has three communication channels coupled thereto and thus has the ability to transmit the information provided thereto from source device 200g to one of three other nodes in the network. In a manner described above, relay module 30 selects one of the three channels (in this example, channel A2) and transmits the information over communication channel A2 to a second medical device 200e.

Medical device 200e has three communication channels coupled thereto and thus has the ability to transmit the information provided thereto to one of three other nodes in the network. In a manner described above, medical device 200e selects one of the three channels (in this example, channel A3) and transmits the information over communication channel A3 to a third medical device 200d. The information then travels along communication channel A4 to a relay module 30, along communication channel A5 to second relay module 30, along A6 to a third relay module 30, along A7 to medical device 200h, along A8 to a relay module 30a, and finally along A9 (which may be a non-mesh network communication path) to access point 40.

In an embodiment, the path that the communication will travel through network 16a is selected prior to sending the communication. For example,

In a similar manner, information sent by medical device 200b travels, for example, along path B1 to medical device 200b, then along path B2 to medical device 200a, then along B3 to access point 40. In an embodiment, path B3 to access point 40 uses a different protocol than the wireless relay network 16a. For example, path B3 may be a Wi-Fi, Ethernet, GSM, or other type of network for communicating with access point 40. As noted above, one or more medical devices 200 may have a first transmitter for transmitting data to the wireless relay network 16a, and a second transmitter for transmitting data to other types of communication paths (e.g. communication path B3) and to other types of networks.

In some embodiments, once data is received by a relay module 30 or 30a from a medical device 200, the data will subsequently be transmitted only to other relay modules while it travels to access point 40. In other embodiments, any path between medical devices and relay modules is permitted.

As another example, medical device 200f is shown as connected only to medical device 200e. If medical device 200f has no other active connections, medical device 200f may only be able to send and receive data to and from medical device 200e.

Allowing medical devices to relay network traffic may provide a number of benefits. For example, if the medical devices are mobile and the relay modules 30 are not, the medical devices may effectively extend the range of the wireless network by acting as network relays with respect to each other. This can also reduce power use and conserve battery time of the medical devices. If a medical device is far from another network access point, it may require more power to send and receive wireless signals. However, if medical devices can send and receive data to other medical devices, which may be in close proximity to send and receive wireless transmissions, less power may be needed for the medical devices to communicate over the mesh network. By providing a mesh network where medical devices and relay modules are relatively close together, the medical devices (and/or relay modules) may use less power to transmit network data. Thus, medical devices and relay modules that use battery power can be designed smaller and lighter and with smaller, lighter batteries.

In an embodiment, the medical device may determine a network status of the network or networks on which it communicates. If one network is unavailable, the medical device may communicate with other devices over other network links. As an example, medical device 200a is shown in communication with medical device 200b, a relay module 30, and WAN access point 40. Medical device 200a may send a query to one or more of these devices to determine whether medical device 200b, a relay module 30, and WAN access point 40 are accessible via network 16. The query may be a network communication requesting a status update from the other device. In response to the query, the other device (e.g. medical device 200b, the relay module 30, and/or WAN access point 40) may send a response informing medical device 200a of the network status of the device. The network status may include information about whether the device is currently capable of communicating over network 16a. If the device is capable of communicating, medical device 200a may then send information to the device, which may then be propagated to other devices through network 16a.

As another example, if no response to the query is received, medical device 200a may determine that the status of the device is currently inaccessible and that the device cannot currently communicate over network 16a to the other device.

A medical device can also send network connectivity information to other medical devices (or other relay modules or other devices) on network 16. Say, for example, that medical device 200d is able to establish a connection to medical device 200c and to a relay module 30, but is unable to establish a connection to medical device 200f. Medical device 200d can send this information about which devices it can connect to, and which device it cannot connect to, to medical device 200c, the relay module 30, or any other device on network 16. Medical device 200d can send the information in response to a query, or can send the information over the network periodically in order to update network connectivity information in the mesh network.

If the device is accessible, the device may send an acknowledgement. For example, if a command to perform a test is sent through network 16, and through medical device 200c, to medical device 200b, then medical device 200b may send an acknowledgement that the command was received, Medical device 200b can also send an acknowledgement when the test is complete, when test data is available, when test data has been transmitted over network 16, etc. The acknowledgement can be sent from medical device 200b to medical device 200c for propagation through network 16, or can be send to any device currently in communication with medical device 200b.

After the medical device, say medical device 200g for example, transmits medical data through the network to another device on network 16a, or to a device on another network or the internet, the medical device may wait to receive an acknowledgement from the other device that the other device received the transmission. If medical device 200g does not receive the acknowledgement, it may assume that its transmission was not received and attempt to transmit the data again. Accordingly, the other devices may monitor a network status of medical device 200g. If a network connection between medical device 200g becomes unavailable or broken, the other devices sending the acknowledgment may find another route through network 16a that can be used to send the acknowledgment (or other data) to medical device 200g.

In an embodiment, medical devices 200a-200h can send an alarm event to another medical device for propagation over network 16a. If, for example, test data recorded by medical device 200f indicates that a patient is in need of critical care, medical device 200f can send an alarm signal to medical device 200e. Medical device 200e can then propagate the alarm by sending it to another medical device such as medical device 200d, to a relay module 300, or to any other network device that has established a communication like with medical device 200e.

The devices in network 16 can route the alarm signal to its destination where it may be received by an emergency responder such as an EMT, a nurse, a doctor, or another type of care-giver. The alarm signal can include information about the type of emergency, the location of the patient, the patient's medical conditions, or any type of information that may be of interest to the emergency responder. In an embodiment, once the emergency responder receives the alarm, the emergency responder can remotely control one or more of the medical devices, if appropriate, to administer aid to the patient.

If the medical device is unable to connect to any other device on network 16a, the medical device can initiate an alarm by creating an audible sound, flashing lights, a flashing display, or other audible or visible means to alert people nearby to the alarm condition. The medical device may also initiate the alarm by creating an audible or visible alarm if it can connect to other devices on network 16a.

In certain situations, the alarm signal may initiate a telephone call to the emergency responder. If the medical device is directly connected to a telephone line or connected to a wireless mobile phone network, the medical device that initiates the alarm can directly initiate the telephone call. Alternatively, the medical device can send the alarm signal to another medical device (or another device on network 16) for propagation through network 16 to a destination end point that can place the telephone call to the emergency responder.

In embodiments, medical devices 200a-200h monitor their power sources and can initiate an alarm if power is low or unavailable. The medical device may include a first power source, such as line power that can be plugged into a wall outlet or other external power source, and one or more second powers source such as a battery. Either power source may provide power to the medical device while the medical device is operating. In an embodiment, if the medical device is plugged into an external power source such as a wall outlet, the medical device can draw its power from the wall outlet and simultaneously charge any rechargeable battery power sources available to the medical device. In certain embodiments, the primary power source for the medical device is an external power source and a batter is used as a secondary, backup power source in case of a power failure. In other embodiments, especially if an external power source is not available at the patient's location, a battery may be used as the primary power source for the medical device.

During operation, the medical device may monitor the status of any power sources associated with the medical device including AC power, battery power, etc. The medical device may include voltage meters, current meters, power meters, or other electronic sensors that can determine whether power from a particular power source is available. If the power source is a battery, the medical device may use its power sensors to determine a charge-level of the battery. The medical device can determine whether the charge-level of the battery is below one or more predetermined thresholds, such as a fully-charged threshold, a low-battery threshold, a critically low-battery threshold, etc. The levels of these thresholds can be set according to design requirements of the medical device.

If any of the power sources available to the medical device experience a power failure, or if the medical device determines that the charge level of a battery power source is below one or more predetermined thresholds, the medical device can initiate an alarm, as described above. The alarm can be sent to another medical device, to relay module, or to any other device that is in communication with the medical device. Also as described above, the power alarm can be propagated through network 16 until it reaches its destination and/or can initiate a telephone call to a responder. If network 16 is unavailable to the medical device, the medical device can initiate an audible and/or visible alarm to alert any people nearby of the power level.

Data sent by any of the medical device (and or wireless relay modules), can travel along any appropriate path within network 16a. The data may take the shortest path (i.e. the path with the fewest number of hops) to its destination, the quickest path (i.e. the path with the lowest delay or latency time) to its destination, or any other path depending on the connection status of the networked devices, the determination of access status made by the medical devices and wireless relay modules, etc. For example, in an embodiment, data sent by medical device 200g may follow path A (i.e. the path illustrated by the arrows labeled “A1-A9” in FIG. 8), through various relay modules 30, medical devices 200e, 200d, and 200h, and a relayed module 30a, before it reaches access point 40. As another example, data transmitted by medical device 200c may follow path B (i.e. the path illustrated by the arrows labeled B1-B3 in FIG. 8), through medical devices 200b and 200a, and without being transmitting through a wireless relay module, before it reaches access point 40. Path C (illustrated by the arrows labeled C1 and C2) is an example of a network path where the data travels from medical device to medical device, until the data reaches a relay module. Once the data reaches a relay module, it may travel directly to access point 40 or through other relay modules on its way to access point 40.

Of course it is not required for the data to reach access point 40 if, for example, the intended destination of the data is a destination within network 16a. Data generated by a medical device or relay module in network 16a may follow any path through network 16a to another medical device or relay module communicating on network 16a, or to any other type of networked device, such as a remote monitoring device for example, that is communicating on network 16a or another network.

In an embodiment, a medical device 10 may have access to a formula library to help determine whether the medical device 10 is administering patient care properly. The formula library can be a database stored in a memory of the medical device 10, stored in an external device such as a server or a wireless relay module, or both. If the database is stored, at least in part, in an external device, the medical device 10 may access the database by communicating with the external device via the wireless relay network and/or the WAN.

Medical device 10 can also measure and/or monitor its administration of care to a patient. For example, if medical device 10 is an enteral feeding pump, medical device 10 may retain information about the timing and amount of nutrition that it has administered to a patient. The information can include the amount of administration, the time and date of administration, the frequency of administration, etc. The database of formula libraries can include formulas for what is being fed to a patient. In such an embodiment, the enteral feeding pump may use such formulas to determine what levels, amount, and frequency of nutrition to feed the patient.

In embodiments, medical device 10 adjusts the level, amount, frequency, and mix of nutrients delivered to the patient. Because medical device 10 (and/or an external device) can retain a history of what has been administered, medical device 10 can use the history to make changes to or adjust the formula of nutrients given to the patient. Medical device 10 can adjust the formula based on what has already been administered to the patient, the time or frequency that a dosage or treatment has been administered, etc. Medical device 10 can also adjust the formula based on medical information obtained from the patient. For example, medical device 10 may receive medical information about the patient such as blood test results, blood pressure, pulse, etc. or other measurements relating to patient health. Medical device 10 may adjust the formula that defines which medicines or nutrients (and their dosages) are administered to the patient based on the medical information about the patient.

As noted above, remote users can send commands to the medical device to perform tests, change the amount of drugs or nutrients administered to the patient, or make other changes to the way the medical device is operating. These commands, as well as information about the authenticated user who issued the command, can be stored to provide a history of which commands were sent to the medical device and by whom.

The history of what has been administered to a patient can be used to determine whether the patient received what was prescribed, i.e. which medicines and in which dosages, what level of nutrients, etc. This data can be used to check patient history as well as be used for compliance reporting.

The history can be restricted to a particular type of user, such as an authenticated doctor, nurse, or caregiver if desired.

In an embodiment, the medical device 10 directly performs medical tests on the patient to measure patient medical information that can be used to adjust the formula. In another embodiment, the medical device 10 receives patient medical information from another device communicating on the wireless relay network or WAN (such as another medical device, relay module, monitoring station, or server, for example).

In some instances, a user may modify the formula directly. In this case, the medical device or server that hosts the formula (or the database containing the formula) can restrict access to the database to only authorized users. For example, in some instances, only a doctor should be able to make changes to the formula. In other instances, it may be permissible for a nurse or caregiver to make changes to the formula. To restrict access, the medical device or server may require a user to authenticate (e.g. log in with credentials such as a username and/or password, or RFID tag, for example) that he or she is authorized to make changes to the formula.

In an embodiment, the medical device can issue an alert (for example as described above) if the formula changes, if a dosage changes, or if the patient has been inadvertently given a dosage that does not comply with the patient's medical plan (due to user error or a device malfunction, for example).

Information about the formula being administered to a patient, patient status, controls for changing the formula, and any alerts can be displayed on user interfaces on the medical device, a wireless relay module in communication with the medical device, a server in communication with the medical device, a remote monitoring station in communication with the medical device, etc.

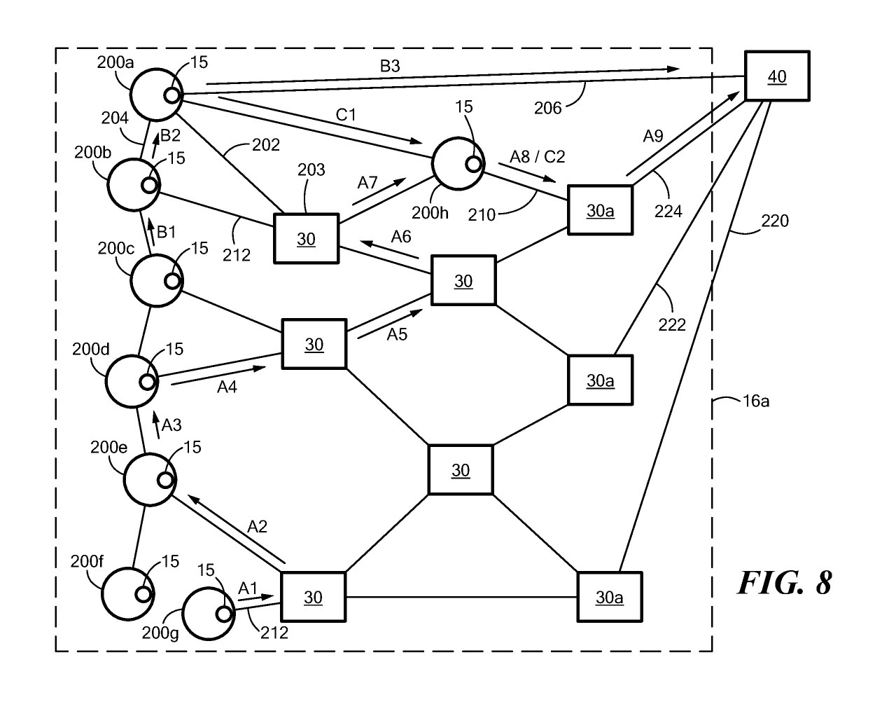

Referring now to FIG. 9, a network diagram shows a wireless relay network 900, including medical devices 200a, 200b, and 200h; and a relay module 30. Wireless relay network 900 may be the same as or similar to wireless relay network 16a in FIG. 8. In an embodiment, network 900 a subset of wireless relay network 16a.

Wireless relay network 900 illustrates a network topology where one (or few) relay modules may act as central hubs and communicate with multiple medical devices. As an example, such a topology may be used in a nursing home where the relay module 30a can be centrally placed between multiple rooms, each room having a patient with a medical device 200a, 200b, or 200h. Although not shown in FIG. 9, relay device 30a may be in communication with an access point 40 so that the medical devices can communicate with remote monitoring stations, remote servers, etc.

If the medical devices are in close enough proximity (in adjacent rooms, for example), the medical devices can establish communication channels between each other, as shown by communication channel 204. As noted above, communication channels between medical devices in the mesh network can provide redundant communication paths to relay module 30a. For example, if medical device 200b were located in a room relatively distant from relay device 30a, communication channel 902 may be broken or unreliable. In this case, medical device 200b may send medical data to medical device 200a via communication channel 204, which may then relay the data to access point 40.

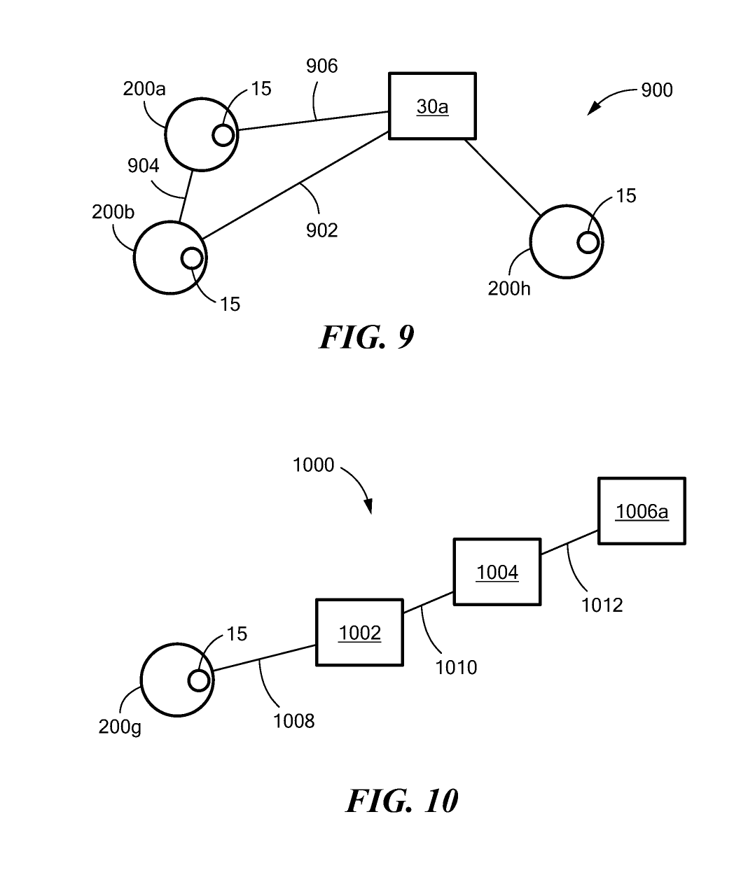

Referring now to FIG. 10, a network diagram shows a wireless relay network 1000, including medical device 200g, wireless relay modules 1002 and 1004 (which may be the same as or similar to relay modules 30), and 1006a (which may be the same as or similar to relay modules 30a). Wireless relay network 1000 may be the same as or similar to wireless relay network 16a in FIG. 8. In an embodiment, wireless relay network 1000 a subset of wireless relay network 16a.

Wireless relay network 1000 illustrates a network topology where multiple relay modules form a daisy-chain to allow medical device 200g to communicate over the network. As an example, such a topology may be used in a hospital (or other facility) where certain areas of the facility do not receive strong wireless network signals. Medical device 200g may be located in a room or location where wireless signals are relatively weak. In this case, relay module 1002 may be placed in or near the room to establish communication channel 1008 with the medical device. Relay module 1002 may also be placed in close enough proximity to relay module 1004 to establish communication 1010, and relay module 1006a may be placed in close enough proximity to relay module 1004 to establish communication channel 1012. Although not shown in FIG. 10, relay device 1006a may be in communication with an access point 40 so that the medical devices can communicate with remote monitoring stations, remote servers, etc. Although not shown, other communication channels between the medical devices and relay modules may be established depending upon proximity of the devices and the mesh network protocols.

Relay modules may also be used in a home care environment. Consider the situation where a medical device such as a medical alarm box is located in one room of the house and the home network is located in another room. A relay module 30 may be placed in a room of the house to establish communication between the alarm box and the home network.

It should of course be understood that while the present technology has been described with respect to disclosed embodiments, numerous variations, alternate embodiments, equivalents, etc. are possible without departing from the spirit and scope of the claims. For example, any of a number of current and future WPAN, WLAN and WWAN standards beyond those explicitly described herein may be used. It should also be understood that it is possible to use exclusively relay modules 30a in the WLAN or WPAN network 16 of FIGS. 1 and 2, with transceivers for communicating with other relay modules as well as over the WWAN.

In addition, respective interface circuits useable with the disclosed technology may include components of and perform the functions of the modules 30, 30a to provide greater flexibility. Further, numerous configurations of components for relay module 30, 30a may be included in relay module 30, 30a. For instance, an input-output buffer may be used with respective switches under control of a processor for directing medical device data to transceivers 31, 32, 37, or 38 as needed. Moreover, it is intended that the scope of the present claims include all other foreseeable equivalents to the elements and structures as described herein and with reference to the drawing figures. Accordingly, the invention is to be limited only by the scope of the claims and their equivalents.

Having described preferred embodiments which serve to illustrate various concepts, structures and techniques, which are the subject of this patent, it will now become apparent to those of ordinary skill in the art that other embodiments incorporating these concepts, structures and techniques may be used. For example, it should be noted that individual concepts, features (or elements) and techniques of different embodiments described herein may be combined to form other embodiments not specifically set forth above. Furthermore, various concepts, features (or elements) and techniques, which are described in the context of a single embodiment, may also be provided separately or in any suitable sub-combination. It is thus expected that other embodiments not specifically described herein are also within the scope of the following claims.

Accordingly, it is submitted that that scope of the patent should not be limited to the described embodiments, but rather should be limited only by the spirit and scope of the following claims.

What is claimed is:

1. A method of transmitting medical information through a wireless relay network comprising a plurality of medical devices capable of wireless data communication and at least one wireless relay module, the method comprising:
receiving medical information in a first medical device;
transmitting the medical information from the first medical device to a second medical device through the wireless relay network;
in response to the second medical device receiving information from the first medical device, transmitting the medical information from the second medical device over the wireless relay network to a first wireless relay module; and
in response to the first wireless relay module receiving medical information over the wireless relay network from the second medical device, selecting, by the first wireless relay module, an internet accessible communication path; and
transmitting the medical information from the first wireless relay module over the selected internet accessible communication path.

2. The method of claim 1 wherein selecting the Internet accessible communication path for transmitting the medical information from the first wireless relay module comprises:
the first wireless relay module determining an access status of an Internet accessible wireless communications network in communication with a transmitter of the wireless relay module and determining a device status for the second medical device and a connection status between the second medical device and the wireless relay module; and
in response to the device status for the second medical device, the determined access status of the wireless relay network, and the connection status of the transmitter and the wireless relay module satisfying a particular criteria, transmitting the medical information from the second medical device over the selected internet accessible communication path.

3. The method of claim 1 wherein the first wireless relay module is a first one of a plurality of wireless relay modules in the wireless relay network and at least one of the plurality of wireless relay modules includes a first transmitter for transmitting over the internet accessible communication path and a second transmitter for transmitting over the wireless relay network, wherein transmitting the medical information from the first wireless relay module over the selected Internet accessible communication path comprises:
the first wireless relay module communicating with at least one of the plurality of wireless relay modules in the wireless relay network;
the first wireless relay module determining an access status of the Internet accessible wireless communications network in communication with the first transmitter of the first wireless relay module, and a device status for each of the at least one medical devices, and a connection status of the second transmitter of first wireless relay module and the wireless relay network;
in response to the determined access status of the wireless relay network, device status for each of the second medical device, and connection status of the first transmitter of the first wireless relay module satisfying a particular criteria, transmitting the medical information from the second medical device over the selected Internet accessible communication path via the first transmitter of the first wireless relay module; and
in response to the determined access status of the wireless relay network, device status for the second medical device, and connection status of the first transmitter of the first wireless relay module failing to satisfy the particular criteria, transmitting the medical information over the wireless relay network via the second transmitter of the first wireless relay module to a second wireless relay module.

4. The method of claim 3 wherein in response to transmitting the medical information over the wireless relay network via the second transmitter of the first wireless relay module, the method further comprises:
receiving the medical information in the second wireless relay module;
the second wireless relay module determining an access status of the Internet accessible wireless communications network in communication with the first transmitter of the second wireless relay module, and a connection status of the second transmitter of second wireless relay module and the wireless relay network;
in response to the determined access status of the wireless relay network, and connection status of the first transmitter of the second wireless relay module satisfying a particular criteria, transmitting the medical information received from the second medical device over the selected Internet accessible communication path via the first transmitter of the second wireless relay module.

5. The method of claim 1 wherein the first wireless relay module is a first one of a plurality of wireless relay modules in the wireless relay network and at least one of the plurality of wireless relay modules includes a first transmitter for transmitting over an Internet accessible communication path and a second transmitter for transmitting over the wireless relay network and the wireless relay network further includes one or more interface circuits in communication with one or more of the plurality of medical devices and one or more of the wireless relay modules, and the method further comprises:
the first wireless relay module communicating with one of a plurality of medical devices and/or wireless relay modules in the wireless relay network;
the first wireless relay module determining an access status of an Internet accessible communication path in communication with a first transmitter of the first relay module, and a device status for at least one of the plurality of medical devices and a connection status of the first transmitter of the first wireless relay module;
the first wireless relay module transmitting the medical information from at least one of the plurality of medical devices over the Internet accessible communication path by the first transmitter if the determined access status of the wireless relay network, device status for at least one medical device, and connection status of the first transmitter of the first wireless relay module satisfy a particular criteria; and
transmitting the medical information from at least one of the plurality of medical devices by a second transmitter in communication with the wireless relay network to a second relay module over the wireless relay network if the determined access status of the wireless relay network, device status of at one medical device, and connection status of the first transmitter in the wireless relay module fail to satisfy the particular criteria.

6. The method of claim 1 wherein the internet accessible communication path allows a medical device located in an area with otherwise low wireless network connectivity to communicate over the network.

7. The method of claim 1 further comprising moving the first or second medical device, wherein the first or second medical device maintains network connectivity by establishing new communication links while it is moved.

8. The method of claim 1 further comprising retaining, by at least one of the medical devices, a history of medical treatment administered to a patient.

9. The method of claim 8 further comprising transmitting the history of medical treatment to a remote monitoring station or server via the internet-accessible communication path.

10. The method of claim 1 further comprising administering, by at least one of the medical devices, medical treatment to a patient according to a medical treatment formula.

11. The method of claim 10 further comprising testing the patient, by the at least one medical device, and adjusting the formula based on results of the testing.

12. The method of claim 1 further comprising sending, by at least one of the medical devices, an alert to a remote monitoring station via the internet accessible communication path.

13. The method of claim 12 further comprising sending the alert in response to a change of a medical treatment formula, a change of a dosage of medicine or nutrients, a result of a test performed by the medical device, or a combination thereof.

14. The method of claim 1 further comprising sending, by at least one of the medical devices via the internet accessible communication path, information about medical treatment administered by the medical device for display on a remote monitoring station.
